(19) United States
(12) Patent Application Publication
(10) Pub. No.: US 2026/0359043 A1
(43) Pub. Date: Nov. 12, 2026

(54) DAILY INTERACTIVE USER INTERFACE

(71) Applicant: monday.com Ltd., Tel Aviv (IL)

(72) Inventors: Mor HALIMI, Tel Aviv-Yafo (IL); Eden ZELIVANSKY, Tel Aviv-Yafo (IL)

(73) Assignee: monday.com Ltd., Tel Aviv (IL)

(21) Appl. No.: 19/695,490

(22) Filed: Jun. 2, 2026

Related U.S. Application Data
(63) Continuation of application No. PCT/IL2026/050061, filed on Jan. 19, 2026.
(60) Provisional application No. 63/802,765, filed on May 9, 2025.
(60) Provisional application No. 63/837,205, filed on Jul. 2, 2025.
(60) Provisional application No. 63/883,111, filed on Sep. 17, 2025.

(51) Int. Cl. G06F 8/77; G06F 9/451

(52) U.S. Cl. CPC G06F 8/77; G06F 9/451

(57) ABSTRACT

There is provided a method, comprising: analyzing work activity data of entities from databases hosting tasks associated with shared goals, wherein the work activity data corresponds to defined timeframes for assessing progress towards the shared goals, generating an interactive standup interface based on the analysis, the interactive standup interface comprising an entity selection mechanism and a main display region that presents, for a selected entity, work activity data visualized in a context of the entity's advancement towards the shared goals, and dynamically updating the interactive standup interface in response to a user interaction with the interactive standup interface, by presenting AI-generated natural language summaries of progress towards the shared goals during the defined timeframes based on the analysis of the work activity data, and/or opening the task in the source database according to the user interaction.

### RELATED APPLICATIONS

This application is a Continuation of PCT Patent Application No. PCT/IL2026/050061 having International filing date of Jan. 19, 2026 which claims the benefit of priority under 35 USC § 119(e) of U.S. Provisional Patent Application Nos. 63/802,765 filed on May 9, 2025, 63/837,205 filed on Jul. 2, 2025 and 63/883,111 filed on Sep. 17, 2025. The contents of the above applications are incorporated by reference as if fully set forth herein in their entirety.

### BACKGROUND

The present invention, in some embodiments thereof, relates to interactive user interfaces and, more specifically, but not exclusively, to a daily interactive user interface.

Daily standup meetings are fundamental ceremonies in Agile software development methodologies, serving as brief synchronization sessions where team members communicate progress, obstacles, and upcoming work. These meetings typically follow a structured format where each participant reports on completed tasks, current activities, and any impediments blocking progress.

### SUMMARY

According to a first aspect, a system for generating an interactive standup interface, comprising: one or more processors configured to: analyze work activity data of each of a plurality of entities from one or more databases hosting tasks associated with at least one shared goal, wherein the work activity data corresponds to at least one defined timeframe for assessing progress towards the at least one shared goal, generate an interactive standup interface based on the analysis, the interactive standup interface comprising an entity selection mechanism and a main display region that presents, for a selected entity, work activity data visualized in a context of the entity's advancement towards the at least one shared goal, and dynamically update the interactive standup interface in response to a user interaction with the interactive standup interface, by presenting AI-generated natural language summaries of progress towards the at least one shared goal during the at least one defined timeframe based on the analysis of the work activity data, and/or opening the task in the source database according to the user interaction.

According to a second aspect, a computer-implemented method for generating an interactive standup interface, comprises: analyzing work activity data of each of a plurality of entities from one or more databases hosting tasks associated with at least one shared goal, wherein the work activity data corresponds to at least one defined timeframe for assessing progress towards the at least one shared goal, generating an interactive standup interface based on the analysis, the interactive standup interface comprising an entity selection mechanism and a main display region that presents, for a selected entity, work activity data visualized in a context of the entity's advancement towards the at least one shared goal, and dynamically updating the interactive standup interface in response to a user interaction with the interactive standup interface, by presenting AI-generated natural language summaries of progress towards the at least one shared goal during the at least one defined timeframe based on the analysis of the work activity data, and/or opening the task in the source database according to the user interaction.

In a further implementation form of the first and second aspects, the one or more databases comprise at least one of: software development repositories, project management systems, and work management platforms.

In a further implementation form of the first and second aspects, the one or more processors are configured to access a repository of feedback data associated with the at least one shared goal, and map the feedback data to tasks associated with the at least one shared goal, and the interactive standup interface presents a summary of the mapped feedback data corresponding to tasks associated with the at least one shared goal presented for the selected entity.

In a further implementation form of the first and second aspects, the entity selection mechanism comprises an entity navigation panel presenting a list of the plurality of entities for selection.

In a further implementation form of the first and second aspects, the one or more processors are configured to manage a virtual entity that maintains unclaimed tasks associated with the at least one shared goal, the unclaimed tasks being accessible for assignment to available entities.

In a further implementation form of the first and second aspects, the virtual entity is configured for automatically capturing tasks without designated owners, and in response to selection of the virtual entity, the captured tasks are presented as available work items for selection in the interactive standup interface by other entities.

In a further implementation form of the first and second aspects, the one or more processors are configured to generate AI-powered risk analysis for each task indicating likelihood of not achieving the at least one shared goal during the at least one defined timeframe, and/or compute a general risk level for each entity indicating likelihood of not achieving the at least one shared goal during the at least one defined timeframe based on task completion patterns and timeline adherence.

In a further implementation form of the first and second aspects, the one or more processors are configured to arrange a presentation of the plurality of entities within the interactive standup interface according to a prioritization condition selected from: most problematic entities, entities with most assigned tasks, and key task completion contributors.

In a further implementation form of the first and second aspects, the one or more processors are configured to generate the AI-generated natural language summaries of progress for entities that are absent, based on analysis of the work activity data of the absent entities.

In a further implementation form of the first and second aspects, the interactive standup interface further comprises a supervisory dashboard for access by an entity having suitable access permissions, the supervisory dashboard presenting additional contextual information unexposed to other entities, the additional contextual information including an AI-generated natural language summary selectively redacted from the main display region for entities that do not have the suitable access permissions.

In a further implementation form of the first and second aspects, the interactive standup interface presents a graphical indicator identifying the entity of the plurality of entities that contributed most significantly toward advancement of the at least one shared goal during the at least one defined timeframe.

In a further implementation form of the first and second aspects, the interactive standup interface presents a graphical progress indicator element depicting advancement by individual entities towards the at least one shared goal during the at least one defined timeframe, and presenting collective advancement by a group of entities toward the at least one shared goal during the at least one defined timeframe.

In a further implementation form of the first and second aspects, the graphical progress indicator is presented as a path on a graph towards the at least one shared goal, the path indicating a plurality of milestones to meet or that were met during the at least one defined timeframe.

In a further implementation form of the first and second aspects, at least one of the plurality of entities is an AI-agent instance designed to automatically perform work activity on allocated tasks towards the at least one shared goal, wherein the one or more processors analyze work activity data of the AI-agent instance, wherein the work activity data is associated with the at least one shared goal and corresponds to the at least one defined timeframe.

In a further implementation form of the first and second aspects, the one or more processors are configured to: generate classification labels for currently active tasks assigned to entities and presented within the interactive standup interface, and provide real-time editing capabilities via the interactive standup interface for enabling immediate task modification.

In a further implementation form of the first and second aspects, the one or more processors are configured to generate task recommendations for future work assignments for each entity, based on at least one of: capability of the entity, capacity of the entity, and the at least one shared goal.

In a further implementation form of the first and second aspects, the one or more processors are configured to maintain historical context across a plurality of historical sessions presented by the interactive standup interface and provide trend analysis for recurring issues and/or progress patterns toward the at least one shared goal.

In a further implementation form of the first and second aspects, the at least one defined timeframe corresponds to an Agile development sprint period, and the at least one shared goal includes sprint objectives for software development project completion.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system for generating an interactive user interface, in accordance with some embodiments of the present invention;

FIG. 2 is a flowchart of a method for generating an interactive user interface, in accordance with some embodiments of the present invention;

FIG. 3 is a schematic of an interactive user interface designed for presenting data for a daily standup meeting, in accordance with some embodiments of the present invention; and

FIG. 4 is a schematic depicting a zoom-in view of an interactive user interface, in accordance with some embodiments of the present invention.

### DETAILED DESCRIPTION

The present invention, in some embodiments thereof, relates to interactive user interfaces and, more specifically, but not exclusively, to a daily interactive user interface.

As used herein, the terms standup interface, interactive user interface and interactive standup interface are used interchangeably. The standup interface, interactive user interface, and/or interactive standup interface, may be implemented as a graphical user interface (GUI).

As used herein, the term shared goal may refer to a defined project objective and/or deliverable that requires contributions from multiple entities for completion. The shared goal may be associated with completion criteria and/or at least one defined timeframe for achievement. Examples of shared goals include: “deploy secure authentication system by March 14, 2024,” “achieve 95% code coverage for financial transaction system,” or “complete Phase II trial enrollment of 200 participants within 6-month recruitment period.” A shared goal may be associated with one or more measurable outcomes, for example, software feature deployment, production targets, quality metrics, and/or project milestones.

As used herein, the term defined timeframe may refer to a predetermined period established for achieving the shared goal(s), representing the total duration allocated for completing work toward project objectives. The defined timeframe may have defined start and end boundaries. Examples include: a 2-week Agile sprint (e.g., March 1-14, 2024), a 6-month clinical trial recruitment period, a quarterly business cycle, or an 18-month construction project phase. The defined timeframe may be associated with the shared goal and may remain constant throughout the project phase regardless of when standup meetings occur.

An aspect of some embodiments of the present invention relates to systems, methods, computing devices, and/or code (stored on a data storage device and executable by one or more processors) for generating an interactive standup interface, optionally for a standup meeting, for example, a daily standup meeting. Work activity data of each one or of entities from one or more databases hosting tasks associated with a shared goal(s) is automatically analyzed. The work activity data corresponds to one or more defined timeframes for assessing progress towards the shared goal(s). An interactive standup interface is automatically generated based on the analysis. The interactive standup interface includes an entity selection mechanism and a main display region. The entity selection mechanism is designed for selecting one of the entities working towards the shared goal. The main display region presents, for the selected entity, work activity data visualized in a context of the entity's advancement towards the shared goal. The interactive standup interface is automatically updated in response to a user interaction with the interactive standup interface. AI-generated natural language summaries of progress towards the shared goal(s) during the defined timeframe(s) based on the analysis of the work activity data, are presented. Alternatively or additionally, the task in the source database is opened according to the user interaction.

At least one embodiment addresses the technical problem of improving standard presentation tools for daily (or other time intervals, such as weekly, monthly, and the like) standup meetings, which are often being time-consuming, unfocused, and/or failing to generate actionable insights. Teams waste time on vague check-ins, and it is difficult to assess blockers, understand shared task dynamics, and/or incorporate customer feedback in real time.

At least one embodiment improves the technology of interactive user interfaces, such as graphical user interfaces (GUI). At least one embodiment improves upon standard presentation tools for daily standup meetings. At least one embodiment provides the practical application of an interactive user interface designed for daily standup meetings.

At least one embodiment improves upon the technology of interactive user interfaces, by providing a user interface that presents specific data and an interactive user interface designed for a user to interact with the specific data. Existing daily standup applications prioritize user navigation mechanics over substantive content analysis and goal-oriented data visualization, which is a fundamental technical limitation. These existing systems fail to establish meaningful connections between displayed work activity data and overarching project objectives, resulting in fragmented status reporting that lacks contextual relevance to shared team goals. Additionally, conventional standup interfaces present static data representations that do not maintain real-time synchronization with underlying project databases, requiring manual data compilation and updates that introduce latency and potential inaccuracies in project status assessment.

At least one embodiment addresses the aforementioned technical deficiencies by implementing a goal-oriented standup interface that analyzes work activity data extracted from databases hosting tasks specifically associated with defined shared goals within predetermined timeframes, thereby enabling visualization of entity progress within the broader context of collective objectives. Unlike prior approaches that focus on basic user-switching functionality, at least one embodiment generates dynamic interactive interfaces that present work activity data contextually linked to shared goal advancement, with real-time data mirroring capabilities that automatically synchronize task status changes between the standup interface and source databases. The technical architecture implemented by at least one embodiment enables interactive data access through AI-generated natural language summaries and direct database connectivity, providing time-bounded assessments of entity progress toward shared goals during defined sprint periods, thereby transforming standup meetings from routine status updates into data-driven project advancement evaluations.

At least one embodiment provides technological improvements to the technology of interactive user interface architectures through goal-oriented data visualization. Unlike traditional user interfaces that display static task information disconnected from project objectives, the interactive user interface implemented by at least one embodiment establishes computational linkages between extracted work activity data and shared goal parameters within defined temporal boundaries, enabling contextual data presentation that reflects entity progress toward collective objectives. The interactive user interface implemented by at least one embodiment may implement AI-powered natural language processing capabilities integrated with interactive elements, whereby user interactions with displayed tasks trigger automated generation of contextual summaries or direct database access, providing dynamic information retrieval functionality not present in static display systems. Additionally, the interactive user interface implemented by at least one embodiment may include visualization components, for example, graphical progress indicators and/or risk analysis displays that computationally process temporal work activity data to present advancement metrics toward shared goals computed from the work activity data, thereby transforming generic task display interfaces into goal-specific project management visualization systems that provide enhanced decision-making capabilities for project leadership through automated analysis of entity performance patterns within sprint timeframes. Examples of advancement metrics include: task completion percentages, story point velocity (e.g., completed story points per unit time), code contribution metrics (e.g., lines of code written/modified, commits, pull requests), timeline adherence rates (e.g., percentage of tasks completed by estimated dates), test coverage percentages, capacity utilization ratios (e.g., committed hours/available hours), and risk-adjusted progress scores accounting for task priority and complexity weighting factors.

At least one embodiment solves upon the aforementioned technical problem, and/or improves the aforementioned technical field, and/or improve upon the aforementioned prior approaches, and/or provides the aforementioned practical application, by automatically analyzing work activity data of each one or of entities from one or more databases hosting tasks associated with a shared goal(s). The work activity data corresponds to one or more defined timeframes for assessing progress towards the shared goal(s). An interactive standup interface is automatically generated based on the analysis. The interactive standup interface includes an entity selection mechanism and a main display region. The entity selection mechanism is designed for selecting one of the entities working towards the shared goal. The main display region presents, for the selected entity, work activity data visualized in a context of the entity's advancement towards the shared goal. The interactive standup interface is automatically updated in response to a user interaction with the interactive standup interface. AI-generated natural language summaries of progress towards the shared goal(s) during the defined timeframe(s) based on the analysis of the work activity data, are presented. Alternatively or additionally, the task in the source database is opened according to the user interaction.

At least one embodiment described herein relates to an interactive user interface designed to enhance daily standups with AI-generated updates, risk analysis, and/or actionable recommendations.

At least one embodiment described herein relates to an interactive user interface configured to generate user updates based on work activity data, summarize customer feedback, analyze team dynamics, and provide a dedicated risk-assessment view for team leads.

At least one embodiment is configured to convert routine status meetings, such as daily standups, into data-driven sessions by automatically identifying risks and generating suggested actions based on the analyzed work activity data and shared goal parameters.

At least one embodiment relates to an interactive user interface configured to improve efficiency of recurring meetings such as daily standups by providing a structured, data-driven view of recent work activity for each entity. The interactive user interface is configured to guide entities through a standardized check-in process by automatically presenting recent activity, planned work, and identified blockers, thereby reducing delays associated with manual recollection of work performed.

The interactive user interface may be configured to present task recommendations for each entity, the recommendations being generated by an AI-agent instance based on one or more of: the entity's prior work activity, capability, capacity, and the at least one shared goal.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

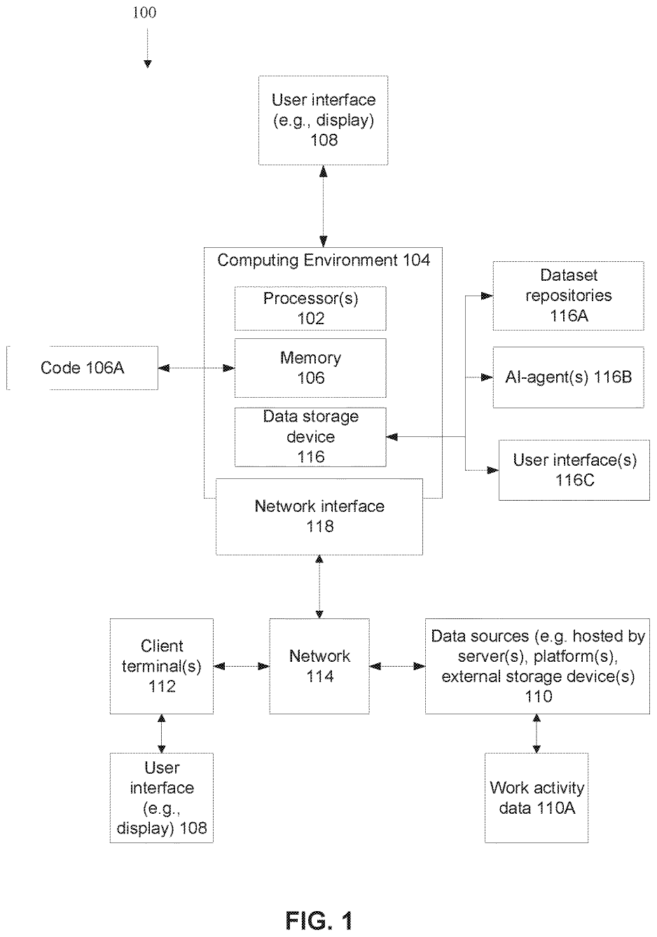

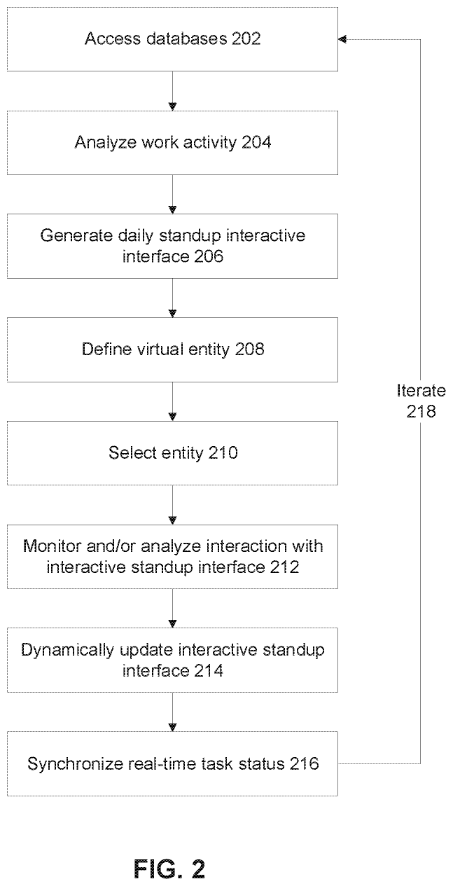

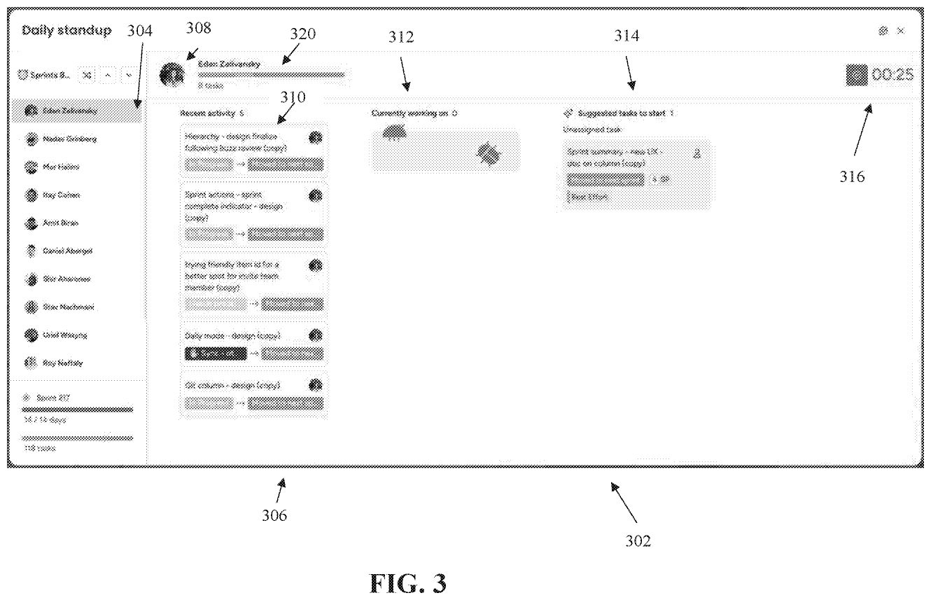

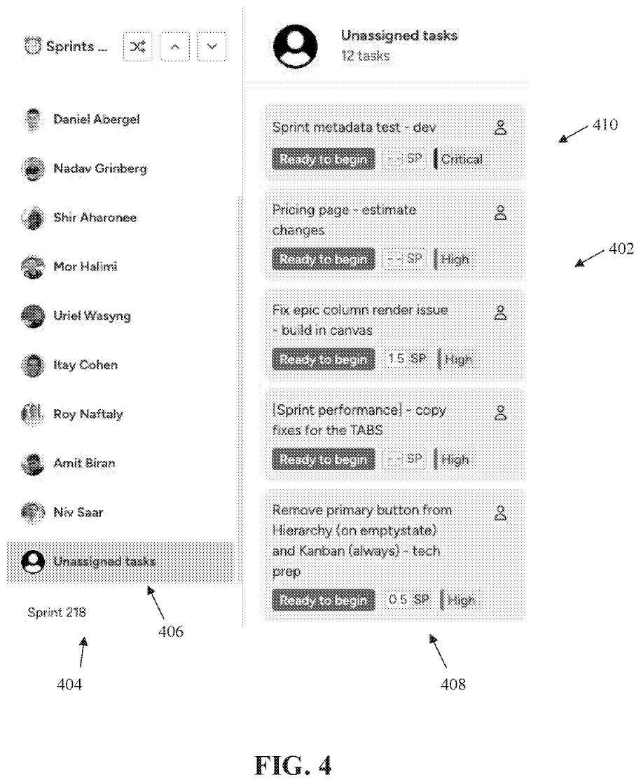

Reference is now made to FIG. 1, which is a block diagram of a system 100 for generating an interactive user interface, in accordance with some embodiments of the present invention. Reference is also made to FIG. 2 which is a flowchart of a method for generating an interactive user interface, in accordance with some embodiments of the present invention. Reference is also made to FIG. 3, which is a schematic of an interactive user interface 302 designed for presenting data for a daily standup meeting, in accordance with some embodiments of the present invention. Reference is also made to FIG. 4, which is a schematic depicting a zoom-in view of an interactive user interface 402, in accordance with some embodiments of the present invention.

System 100 may implement the acts of the method(s) described herein, for example described with respect to one or more other Figures, by processor(s) 102 of a computing environment 104 executing code instructions (e.g., code 106A) stored in a memory 106.

Computing environment 104 may be implemented as, for example, one of more of: a server, a computing cloud, a virtual server, and the like. Computing environment 104 may include a single computing environment, and/or a group of computing environments arranged in parallel.

Client terminal(s) 112 access one or more interactive user interface(s) 116C stored and/or managed by computing environment 104. Interactive user interface(s) 116C may be presented on a user interface 108 (e.g., display) associated with client terminal(s) 112. Client terminal(s) 112 may be implemented, for example, a desktop computer, a mobile device, a smartphone, a laptop, a tablet computer, a wearable computing device, a glasses computing device, and a watch computing device.

Computing environment 104 may process work activity data 110A hosted by one or more data sources 110 (e.g., databases), for example, one or more of: a server(s), a platform(s) such as a project management platform, a software development repository, an external computing device, an external storage device(s) (e.g., hard drive, optical drive, computing cloud, virtual storage), a network server, a web server, a storage server, a local server, a remote server, and a computing cloud, and the like. Work activity data 110A from data sources 110 may be presented within user interface(s) 116C.

Exemplary work activity data 110A of data sources 110, optionally databases, are described herein, for example, code repository metadata, code, project management data, and the like.

Computing environment 104 may host and/or execute and/or implement one or more instances of one or more AI-agent instances 116B, as described herein.

AI-agents instances (also referred to herein as machine learning models) described herein may be trained using training examples to generate a trained machine model capable of making inferences and/or predictions on new data. Not necessarily limiting examples of such machine learning models may include natural language processing (NLP) algorithms, such as transformer-based models (e.g., BERT, RoBERTa, and variants thereof), sequence-to-sequence models, and text embedding models; classification and regression algorithms, such as logistic regression or support vector machines; deep learning algorithms using artificial neural networks, including convolutional neural networks (CNNs) or recurrent neural networks (RNNs); topic modeling algorithms such as Latent Dirichlet Allocation (LDA); and other statistical or probabilistic models such as Bayesian networks. The training of such AI-agents may involve training, validation, and/or test examples to determine or refine parameters of the machine learning model. The trained AI-agents may be designed to perform specific tasks described herein.

Computing environment 104 includes one or more processor(s) 102, implemented as for example, central processing unit(s) (CPU), graphics processing unit(s) (GPU), field programmable gate array(s) (FPGA), digital signal processor(s) (DSP), application specific integrated circuit(s) (ASIC), customized circuit(s), processors for interfacing with other units, and/or specialized hardware accelerators. Processor(s) 102 may be implemented as a hardware processor. Processor(s) 102 may be implemented as a single processor, a multi-core processor, and/or a cluster of processors arranged for parallel processing (which may include homogenous and/or heterogeneous processor architectures). It is noted that processor(s) 102 may be designed to implement in hardware one or more features stored as code instructions 106A.

Memory 106 stores code instructions executable by processor(s) 102, for example, a random access memory (RAM), dynamic random access memory (DRAM) and/or storage class memory (SCM), non-volatile memory, magnetic media, semiconductor memory devices, hard drive, removable storage, and optical media (e.g., DVD, CD-ROM). Memory 106 stores, for example, code 106A that when executed by processor(s) 102, implements one or more features and/or acts of the methods described herein.

Computing environment 104 may include a data storage device 116 for storing data, for example, dataset repositories 116A, which include one or more datasets and/or other data described herein, AI-agent(s) 116B as described herein, and/or user interface(s) 116C as described herein. Data repository 116 may be implemented as, for example, a memory, a local hard-drive, virtual storage, a removable storage unit, an optical disk, a storage device, and/or as a remote server and/or computing cloud (e.g., accessed using a network connection).

Computing environment 104 may include a network interface 118 for connecting to network 114, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 114 may be implemented as, for example, the internet, a local area network, a virtual private network, a wireless network, a cellular network, a local bus, a point to point link (e.g., wired), and/or combinations of the aforementioned.

Computing environment 104 may connect using network 114 (or another communication channel, such as through a direct link (e.g., cable, wireless) and/or indirect link (e.g., via an intermediary computing unit such as a server, and/or via a storage device) with data source(s) 110 and/or client terminal(s) 112.

Computing environment 104 and each client terminal 112 may include and/or be in communication with one or more physical user interfaces 108 that include a mechanism for a view and/or interact with user interface(s) 116C. Exemplary user interfaces 108 include, for example, one or more of, a touchscreen, a display, a keyboard, a mouse, and voice activated software using speakers and microphone.

As described above with reference to FIG. 1, system 100 provides a computing environment including processor(s) 102, memory 106, data storage 116, and network interface 118 configured to access work activity data 110A from one or more data sources 110 and to generate interactive user interface(s) 116C. FIG. 2 illustrates, at a higher level of abstraction, a method implemented by processor(s) 102 for generating and updating the interactive standup interface using the components shown in FIG. 1. In particular, each act of the method of FIG. 2 may be carried out by one or more processes executing within computing environment 104 (e.g., ingestion engines, analysis modules, AI-agent instances, and user interface generation modules).

Referring now back to FIG. 2, At 202, one or more databases are accessed, and/or data is extracted from the database(s).

The databases host work activity data performed by multiple different entities. The work activity is associated with tasks, which are associated with one or more shared goals to be achieved by multiple entities, and corresponding timeframes to reach the shared goal(s), for example, sprints based on Agile methodology and/or other production methodology. Examples of databases include: software development repositories, project management systems, and work management platforms.

The databases may host work activity related to different domains where work is done by entities working on tasks to achieve shared goals within defined timeframes, for example, software development, manufacturing, research and development, construction, marketing, finance, and healthcare.

Examples of data accessed and/or extracted data from the databases include:
Status of tasks allocated to each entity.
Associated metadata including, for example, task owner, task priority levels, estimated completion times, and dependency relationships.
Generated and/or edited code including, for example specific metrics such as lines of code added, deleted, or modified, commit frequency, branch creation and merge activities, and code review participation rates.
Comments posted by each entity including, for example, inline code comments, pull request discussions, and issue tracker communications with natural language processing tags for sentiment analysis.
Communication received by each entity from other entities and/or other entities including, for example, direct messages, channel mentions, email threads, and meeting attendance records with timestamp data and participant identification;
Flag and/or status changes made by each entity including, for example, task state transitions (e.g., “to-do” to “in-progress” to “completed”), bug report status modifications, and feature request classifications.

Optionally, the databases include a repository of feedback data associated with the tasks and/or shared goal(s), for example customer experience (CX) feedback data associated with the shared goal. The customer experience feedback data may include, for example, textual comments written in natural language, ratings and/or rankings, issue reports, support ticket volumes, feature requests (e.g., from CRM systems, support tickets database, product review platforms), satisfaction ratings, feature usage analytics, crash reports, and/or performance metrics correlated to specific code contributions or feature releases. Each CX feedback item may include, for example, one or more of: (a) feedback content (e.g., “Login fails on mobile”), (b) metadata tags linking feedback to features or tasks (e.g., task ID “TASK-456”, feature tag “mobile-login”), and (c) timestamps. The system may map feedback to tasks, for example using: (a) Direct identifier matching: When feedback includes explicit task IDs or feature tags, the system performs database lookups to associate feedback with corresponding tasks (e.g., support ticket tagged “TASK-456”→mapped to TASK-456); (b) Semantic analysis fallback: When feedback lacks explicit tags, NLP extracts keywords from feedback text, generates vector embeddings, computes similarity scores with task descriptions, and maps feedback to tasks with similarity scores exceeding a threshold (e.g., cosine similarity>0.75). For example: Feedback “Payment timeout on checkout” (no tags)→keyword extraction [“payment”, “timeout”]→vector similarity 0.82 with “Optimize payment API” (TASK-789)→mapped to TASK-789 and assigned entity. Mapped CX feedback may be presented in the interactive standup interface for entities assigned to associated tasks.

The entities may include human, for example, software developments working on software development projects.

The entities may include AI-agent instances which are designed to automatically perform work on allocated tasks. The AI agent instance may function as an autonomous task execution process that performs software development work without human intervention. Examples of work the AI agent instance may be designed to perform include: code generation, automated testing of code, document processing, data analysis, software deployment, and system integration. Work done by multiple AI agents in different domains may be summarized and presented. Since AI agent instances can operate for hours-the interactive user interface may provide a high-level overview of the work performed by the AI agent instances. The AI-agent instance(s) may be handled similarly to humans, for example, processes analyze the recent work activity of the AI-agent instance(s) and the interactive user interface includes the AI-agent instance, such as the AI-agent instance may be selected, unassigned tasks may be assigned to the AI-agent instance, and/or a summary of recent work performed by the AI-agent instance may be presented, as described herein.

The work activity data may be accessed from the databases, for example, by automated data collection protocols and/or via application programming interfaces (APIs).

Data extraction processes designed to interface with multiple repository types may be implemented, for example, distributed version control systems (e.g., Git repositories, Subversion), integrated development environments (IDEs), continuous integration/continuous deployment (CI/CD) platforms, project tracking systems (e.g., Jira, Asana, Trello), communication platforms (e.g., Slack, Microsoft Teams), and customer relationship management (CRM) systems. Each extraction process may implement specific authentication protocols and/or data parsing processes tailored to the target system's data structure and/or API specifications.

The data may be accessed and/or extracted for a preceding time interval, for example, for the preceding 24-hour period, generated from the preceding data extraction session and/or preceding daily meeting, or other time intervals. The preceding time interval may refer to the period of elapsed time immediately before the current standup meeting, during which recent work activity occurred. The preceding time interval may represent a sliding window that moves forward with each standup meeting. Examples include: the 24-hour period since the previous daily standup, the 72-hour period since the previous weekly meeting, or the time elapsed since the last status update session. The preceding time interval may be used to identify which work activity data is analyzed and presented as recent accomplishments during the current standup meeting.

The data may be accessed by an Ingestion Engine designed to acquire data from the different source described herein. The Ingestion Engine may perform preliminary format normalization. The Ingestion Engine may continuously ingest data from the different sources or at selected time intervals, for example, corresponding to the interval between standup meetings. The Ingestion Engine may employ pull connectors for periodic API polling of SaaS endpoints (e.g., Salesforce, Notion) and/or push connectors, such as webhook listeners, to receive real-time events (e.g., from the Slack Events API). Authentication may be handled via protocols such as OAuth 2.0, with secure token handling. For database sources, the Ingestion Engine may implement log-based Change Data Capture (CDC) to stream inserts and updates.

The Ingestion Engine may process, normalize, and/or structure the raw data into a persistent, unified, and queryable “organizational memory”. The organizational memory may include generated canonical “knowledge objects.” Each knowledge object may represent a unified data asset that encapsulates an element of information from a source system. These knowledge objects may be enriched with metadata that provides temporal, semantic, and/or contextual value. For example, each knowledge object may be versioned with a temporal stamp to provide historical context, and/or converted into a vector embedding to enable semantic understanding, and/or scored with a relevance index to gauge its importance for use in queries. Each knowledge object may represent data associated with work during a preceding time interval, optionally time elapsed from the preceding standup meeting, such as 24 hours or other times. Knowledge objects may be created for each entity.

The knowledge objects may be generated by data from the Ingestion Engine being passed to code executing a Processing & Normalization Pipeline, which may apply schema mapping, type coercion, entity extraction, and/or temporal stamping. The pipeline may convert raw data into a canonical “knowledge object” format. A knowledge object may include fields such as a unique identifier (uid), a source type enumerator (source_type), timestamps (acquisition_timestamp, valid_time_range), the original raw payload (raw_payload), normalized fields, and a vector embedding for semantic search (vector_embedding).

By transforming a chaotic landscape of disparate data into an organized and/or intelligent memory, a single source of recent work activity for each entity, is generated. The knowledge objects may enable the analytical, presentation, and/or dynamic updating capabilities described herein, which may utilized on this clean, structured, and/or contextually-rich data to operate. The knowledge objects may improve a process of analysis described herein, for example, by simplifying the data analyzed to the data within the knowledge object, enabling computation of metrics across time and/or between entities, and the like.

At 204, the work activity data of each one of multiple entities is analyzed.

The analysis may be based on the work activity data of each entity with respect to one or more defined timeframe for assessing progress towards the shared goal(s).

The analysis may be performed by one or more AI-agents trained and/or designed to perform the analysis.

The defined timeframe may correspond, for example, to an Agile development sprint period, a medical device review deadline, a quarterly business review, a service level agreement (SLA) measurement time frame, and the like. The sprint period may refer to a specific implementation of a defined timeframe commonly used in Agile software development methodologies, for example, 1-4 week iterations with fixed start and end dates.

In some embodiments, the system operates with two distinct temporal windows:
(a) Sprint goal window (or shared goal window): The full duration of the defined timeframe from start to projected completion. The sprint goal window may be used for calculating overall progress toward the shared goal (e.g., “71% complete in 2-week sprint”), computing risk scores based on remaining time, and determining timeline adherence. The sprint goal window may span the entire defined timeframe.
(b) Recent-activity summary window: The duration of the preceding time interval immediately before the current standup meeting. This window may be used for identifying which work activities to present as “recent accomplishments” (e.g., “tasks completed in last 24 hours”), generating AI summaries of recent progress, and displaying entity-specific updates. The recent-activity summary window may slide forward with each standup meeting.

For example, in a 2-week sprint running March 1-14, 2024:
Sprint goal window: 14 days (March 1-14)—used to calculate “team is 71% complete toward sprint goal”.
Recent-activity summary window at March 8 standup: 24 hours (March 7-8)—used to display “EntityA completed 3 tasks yesterday”.
Recent-activity summary window at March 9 standup: 24 hours (March 8-9)-used to display “EntityA completed 2 tasks yesterday”.

The sprint goal window remains constant (March 1-14) while the recent-activity summary window advances daily with each standup meeting.

Examples of shared goals for different domains include:
Sprint objectives for software development project completion.
Achieve 90% code coverage for payment processing components by end of current sprint.
Deploy API version 2.1 to production environment within 3-week sprint cycle.
Resolve all critical security vulnerabilities identified in Q3 security audit.
Integrate third-party analytics service with existing dashboard by sprint deadline.
Assembly Line Output Targets: Achieve production of 10,000 automotive brake assemblies within 4-week manufacturing cycle with <0.1% defect rate.
Clinical Trial Phases: Complete Phase II drug trial enrollment of 500 patients within 18-month recruitment period for pharmaceutical development.
Infrastructure Project Completion: Complete highway bridge construction within 24-month contracted delivery timeframe.
Product Launch Campaigns: Achieve 25% market penetration for new consumer product within 12-month launch period.
Cost Reduction Initiatives: Reduce operational expenses by 8% during 6-month efficiency improvement program.
Clinical Outcome Targets: Reduce hospital readmission rates by 12% within 12-month quality improvement initiative.

The analysis may include computing a risk analysis for each task indicating probability of not achieving the shared goal(s) during the defined timeframe(s). Alternatively or additionally, the analysis may include computing a general risk level for each entity indicating likelihood of not achieving the shared goal(s) during the defined timeframe. The risk analysis and/or general risk level may be computed based on task completion patterns and/or timeline adherence, optionally in view of historical performance by individual entities and/or the team of entities.

The analysis may include computing the risk analysis for each task indicating probability of not achieving the shared goal(s) during the defined timeframe(s), for example, by assessment of multiple quantitative metrics. The task-level risk computation may implement statistical models that evaluate completion velocity against remaining time allocation, where the system calculates a completion probability score based on current progress percentage divided by elapsed time percentage within the defined timeframe. For example, if a task labeled “implement user authentication API” shows 30% completion after 70% of the sprint timeframe has elapsed, the risk analysis algorithm may compute a high probability (e.g., 0.8 on a scale of 0-1) of not achieving completion within the remaining timeframe.

In some embodiments, a risk score(s) indicating a probability that a task(s) will not be completed within the defined timeframe(s) and/or or that the shared goal(s) will not be achieved within the defined timeframe(s), is computed. The risk score(s) may be presented in the interactive standup interface, for example, in proximity to corresponding tasks and/or share goal(s). Risk scores may be calculated using statistical models that evaluate, for example: (i) task completion velocity relative to remaining time, (ii) historical completion patterns, (iii) dependency relationships, and/or (iv) blocking conditions. For example, a task-level risk score may be computed as: Risk_Score=1−(Completion_Percentage/Time_Elapsed_Percentage). An entity-level risk score may be computed as a weighted aggregate: Entity_Risk=Σ(Task_Risk_i×Goal_Contribution_i)/Σ(Goal_Contribution_i). Risk scores may be expressed as numerical values (e.g., 0.0 to 1.0), percentages, categorical classifications (e.g., low, medium, high), and/or color-coded indicators.

The risk analysis computation may incorporate dependency mapping processes that identify task interdependencies and calculate cascading risk factors. When Task A depends on completion of Task B, and Task B exhibits delayed completion patterns, the system may automatically increase the risk score for Task A by applying a dependency risk multiplier (e.g., 1.5× base risk score). The system may implement blocking condition detection, where tasks marked as “blocked” or “waiting for review” trigger elevated risk calculations based on historical resolution times for similar blocking conditions.

Alternatively or additionally, the analysis may include computing a general risk level for each entity indicating likelihood of not achieving the shared goal(s) during the defined timeframe through entity-specific performance analytics. The entity risk computation may aggregate individual task risk scores assigned to each entity and apply weighting factors based on task criticality and shared goal contribution percentages. For example, if Entity A is assigned three tasks with risk scores of 0.2, 0.6, and 0.9, and these tasks contribute 10%, 30%, and 60% respectively to the shared goal, the system may calculate a weighted entity risk score of (0.2×0.1)+(0.6×0.3)+(0.9×0.6)=0.74.

The risk analysis and/or general risk level may be computed based on task completion patterns through velocity analysis processes that track completed tasks per time frame and project future completion rates. The system may implement trend analysis, for example, using linear regression and/or polynomial curve fitting and/or using AI-agent instances, to model completion velocity trajectories, calculating confidence intervals for projected completion dates. For example, if an entity completes tasks at a measured rate of 2.5 tasks per week with a standard deviation of 0.8 tasks, and 8 tasks remain with 3 weeks in the sprint, the system may calculate completion probability using statistical distribution models (e.g., normal distribution) yielding a completion probability of 0.65.

Timeline adherence analysis may implement deadline variance calculations that measure actual completion dates against estimated completion dates, computing average deviation metrics and variance patterns. The system may track on-time completion percentages for individual entities and apply these historical success rates to current task assignments. For example, if Entity B historically completes tasks on schedule 75% of the time, current task risk scores may be adjusted by applying a baseline risk factor of 0.25 for timeline adherence failure.

The computation may optionally incorporate historical performance by individual entities through machine learning models that analyze past sprint performance data, task complexity correlations, and entity skill assessments. The system may implement collaborative filtering techniques to identify performance patterns similar to current conditions, using historical data points including task types completed, complexity ratings, and success rates under comparable timeline pressures. Entity performance profiles may include calculated metrics such as average task completion time, standard deviation from estimates, and performance degradation under increased workload conditions.

Historical team performance analysis may implement team velocity calculations using exponential moving averages of completed story points or task counts across previous sprints or defined timeframes. The system may calculate team capacity utilization rates by comparing actual work completed against theoretical maximum capacity, identifying bottlenecks and resource allocation inefficiencies that contribute to goal achievement risk. For example, if historical data shows the team completes an average of 45 story points per sprint with a standard deviation of 8 points, and the current sprint contains 52 story points, the risk analysis may calculate an over commitment probability using statistical models, yielding a team-level risk score for shared goal achievement.

The analysis may include mapping the feedback data to different tasks assigned to different entities associated with the shared goal, for example, through computational correlation processes that compute semantic and contextual linkages between feedback content and specific tasks. The mapping process may implement, for example, natural language processing (NLP) techniques including keyword extraction, entity recognition, and/or semantic similarity analysis, for example, using vector space models, cosine similarity calculations, and/or AI-agents to identify relationships between feedback data elements and task specifications. For example, customer feedback stating “login authentication fails on mobile devices” may be automatically mapped to tasks assigned to Entity A for “mobile authentication implementation” and Entity B for “user login API development” through identification of matching keywords and semantic proximity scoring.

The analysis may include generating automatic summaries of recent activity accomplishments and/or achievements, optionally for the preceding time interval from the preceding standup meeting (e.g., last 24 hours, or 72 hours, or week) and/or in view of the shared goal(s) and/or defined timeframe. Examples of automatic summaries include progress of each task with respect to the shared goal(s) and/or for meeting the defined timeframe. The

The automatic summaries may be generated for entities that are absent during the current standup meeting, based on analysis of the work activity data of the absent entities. This enables the standup meeting to proceed, even when the entity is absent, as if the entity were present.

In some embodiments, when an entity is absent from a standup session, the system is configured to generate a “stand-in” update for that entity by analyzing work activity data from one or more repositories and project management systems using an AI-agent instance. To protect privacy and comply with organizational policies, this functionality may be governed by explicit authorization, consent, policy controls, and logging mechanisms.

As described above, prior to or during a standup session, the one or more processors may determine that a particular entity is absent (e.g., based on meeting attendance indications, calendar signals, or lack of client terminal connectivity). In response, the system may invoke an AI-agent instance that is configured to access the work activity data of the absent entity from one or more databases, such as software development repositories, project management systems, and communication tools, and to generate an AI-produced natural language summary describing recent work activity for that entity.

In some embodiments, the system enforces an authorization and consent model for these stand-in updates. An authorization module may maintain, for each entity, a profile including one or more of:
an explicit consent flag indicating whether the entity has opted in to having stand-in updates auto-generated from their repository activity when they are absent;
permitted data categories that may be included in such updates (e.g., task status changes only; code commit metadata but not commit diffs; public comments but not private messages); and
a list of teams or roles that are allowed to view stand-in summaries for that entity (e.g., immediate team members, team leads, or project managers).

When the AI-agent instance is requested to generate a stand-in update, the one or more processors first consult the authorization module and applicable organizational policies. For example, policy controls may specify that stand-in summaries may only be generated if: (i) the entity has provided consent; and (ii) the requesting context (e.g., the current standup session and its participants) satisfies role-based access rules. If these conditions are not met, the system may either refrain from generating a stand-in summary, or may generate a restricted version based solely on non-sensitive or team-wide visible data (e.g., high-level task status without detailed content).

In one implementation, policy controls are expressed as machine-readable rules that can be evaluated at runtime. Such rules may reference one or more of: the entity's role, the audience of the standup (e.g., team identifier), the type of repository data (e.g., source control vs. HR system), and the sensitivity classification of the data. The AI-agent instance is configured to apply these policy rules by filtering the work activity data prior to analysis, so that only authorized data objects (e.g., specific tasks, commits, or comments) are included in the summarization process.

The system may also implement logging and audit mechanisms for stand-in updates generated via repository access. Each time a stand-in summary is generated for an absent entity, the one or more processors may create a log record including, for example:
an identifier of the absent entity and the requesting standup session identifier;
a timestamp of the summary generation;
a list of data sources accessed (e.g., particular repositories or project boards);
a summary of the policy rules and consent settings that were applied (e.g., “action allowed under policy P1, code diffs excluded”);
an indication of which participants or roles were granted access to view the stand-in summary; and
a hash or reference to the generated summary text for audit purposes.

These log records may be stored in an audit log repository separate from the main work activity data and session snapshots, and may be accessible to administrators or compliance personnel under appropriate permissions. In some embodiments, a subset of this logging information (e.g., a simple “AI stand-in used” indicator) is also stored in the session snapshot for the standup session under a field indicating that the entity's update was auto-generated rather than delivered live.

When the stand-in update is presented in the interactive standup interface, the system may visually distinguish it from live updates. For example, the main display region may include a label such as “AI-generated stand-in update for EntityX (based on authorized repository activity),” or an icon indicating that the content was produced by an AI-agent instance. In some embodiments, hovering over or selecting this label may reveal non-sensitive audit information, such as the time the summary was generated and the data categories included, while more detailed audit logs remain accessible only through administrative tools.

By combining repository-based summarization, explicit authorization and consent controls, policy-driven data filtering, and detailed logging, the system enables automated stand-in updates for absent individuals while maintaining traceability and adherence to organizational access and privacy requirements.

In some embodiments, the generation of automatic summaries for absent entities may operate within a permission-based access control framework. Access permissions may be verified before analyzing work activity data of absent entities. Access permissions may be established through, for example: (a) entity-granted permissions via opt-in consent interfaces where entities authorize automatic summary generation and specify accessible data categories, (b) organizational policy-based permissions configured by administrative entities (e.g., team leads) defining default access policies for team members, (c) repository-based permissions inherited from access control lists (ACLs) or role-based access control (RBAC) systems of the one or more databases, or (d) public/private data classification where public work activity data visible to all team members is accessible without additional authorization while private data requires explicit permission. When an entity is identified as absent, permission verification may be executed, for example, by: retrieving stored permission settings, determining authorization status, filtering work activity data to include only authorized categories, and generating summaries based on filtered data. If permissions are insufficient, the interface may present a notification indicating restricted access and/or a limited summary from public data may be generated.

The automatic summaries may be generated for an AI-agent instance, which is defined as one of the entities of a team working on a project towards the shared goal(s). The AI-agent instance is designed to automatically perform work activity on allocated tasks towards the shared goal.

The automatic summary may generated by another AI agent instance for each entity in natural language. The automatic summary may be generated in text, for presentation on a display and/or for being read by the entity. For example, “Yesterday I worked on task C54A, today I will work on task D4AY”. Alternatively or additionally, the automatic summary may be synthesized into an audio format to be played over speakers based on the voice of the entity.

The AI agent instance may generate the natural language summary of progress for each entity for the recent time interval based on the analysis of the recent work activity for the entity. Examples of natural language summaries include: automatically generated summaries of completed tasks, code contributions, project progress achieved within the preceding 24-hour period, and summary of client feedback. Such AI agent instance may be trained, for example, on a training dataset of sample input of recent work activity and a ground truth of natural language summaries, and/or using other approaches described herein.

Other examples of automatically generated summaries of recent work activity achieved from the preceding standup meeting (e.g., last 24 hours) with respect to tasks, shared goals, and/or defined timeframes include:
Software Development Sprint Example: Task: “Implement OAuth 2.0 token validation logic” Shared Goal: “Deploy secure authentication system for Sprint 15” Defined Timeframe: “2-week Sprint 15 (March 1-14, 2024)” Daily Summary: “EntityBackendA: Since yesterday's standup, completed token expiration handling function (87 lines of code), wrote 12 unit tests achieving 92% coverage for validation module, and resolved merge conflict with EntityFrontendB's login integration branch. Task AUTH-401 advanced from 65% to 78% completion, maintaining Sprint 15 timeline for secure authentication system goal.”
Manufacturing Project Example: Task: “Calibrate robotic arm positioning system” Shared Goal: “Increase Assembly Line 3 throughput to 200 units/hour” Defined Timeframe: “4-week automation upgrade (April 1-28, 2024)” Daily Summary: “EntityRoboticsTechD: Since yesterday's standup, completed X-axis calibration achieving ±0.2 mm precision, programmed 8 welding sequences for product variants A through H, and conducted 4-hour continuous operation test producing 47 units without errors. Task AUTO-156 advanced from 55% to 75% completion, on schedule for Assembly Line 3 throughput goal within 4-week automation timeframe.”
Clinical Research Examples: Task: “Process participant screening questionnaires” Shared Goal: “Enroll 200 participants in Phase II diabetes trial” Defined Timeframe: “6-month recruitment period (Jan 1-Jun 30, 2024)” Daily Summary: “EntityResearchCoordinatorE: Since yesterday's standup, reviewed 23 screening questionnaires, qualified 8 participants meeting inclusion criteria, scheduled 12 baseline visits for next week, and updated enrollment database with demographic data. Task RECRUIT-089 progressed from 127 to 135 enrolled participants (67.5% of 200-participant Phase II trial goal), maintaining 6-month recruitment timeline.”
Construction Project Examples: Task: “Install electrical conduits in Building Section B” Shared Goal: “Complete 80-unit residential complex electrical systems” Defined Timeframe: “16-week electrical installation phase (Feb 15-Jun 7, 2024)” Daily Summary: “EntityElectricianF: Since yesterday's standup, installed 340 feet of EMT conduit on floors 2-3, completed junction box mounting for 12 apartment units, passed rough electrical inspection for Units 201-206, and coordinated with EntityPlumbingG for utility space allocation. Task ELEC-078 advanced from 32% to 38% completion toward 80-unit electrical systems goal within 16-week installation timeframe.”
AI Agent Task Examples: Task: “Generate unit tests for payment processing module” Shared Goal: “Achieve 95% code coverage for financial transaction system” Defined Timeframe: “3-week testing sprint (March 5-25, 2024)” Daily Summary: “EntityAIAgentG: Since yesterday's standup, automatically generated 34 unit test cases for payment validation functions, identified 3 edge cases in refund processing logic, executed 156 test scenarios with 97.3% pass rate, and updated test documentation with coverage metrics. Task TEST-234 progressed from 71% to 84% completion, exceeding trajectory for 95% code coverage goal within 3-week testing sprint.”
Marketing Campaign Examples: Task: “Create social media content for product launch” Shared Goal: “Generate 10,000 qualified leads for new SaaS platform” Defined Timeframe: “8-week launch campaign (April 1-May 26, 2024)” Daily Summary: “EntityContentCreatorH: Since yesterday's standup, produced 5 LinkedIn posts, 8 Twitter threads, 2 Instagram carousel posts, scheduled content delivery for next 72 hours, and analyzed engagement metrics showing 23% increase in click-through rates. Task SOCIAL-167 advanced from 45% to 52% completion, tracking toward 10,000 qualified leads goal within 8-week launch campaign timeline.”

The analysis may include generating classification labels for currently active tasks. The interactive user interface may provide real-time editing capabilities enabling immediate task modification via the interactive user interface. Examples of classification labels include: done, ready to begin, waiting for review, priority (e.g., critical, best effort, high, medium, low), owner and the like. The classification labels may be presented for a subset of tasks assigned to the selected entity. The classification labels may be generated by another AI agent instance. Such AI agent instance may be trained, for example, on a training dataset of sample currently active tasks and ground truths of classification labels. The AI agent instance may dynamically learn from manual user corrections and/or updates of the classification labels.

The analysis may include generating task recommendations for future work assignments for each entity, optionally by yet another AI agent instance. The AI agent instance may implement machine learning models such as collaborative filtering, content-based recommendation systems, and/or neural network architectures trained on historical task assignment patterns and completion outcomes. The task recommendations are based on analysis of, for example, one or more of: extracted recent work activity, historical performance data, and/or multi-dimensional parameters, such as entity capability assessment (e.g., by competency scoring processes that evaluate technical skill levels and/or domain expertise), entity capacity analysis (e.g., using workload utilization calculations and/or cognitive load assessments), project status evaluation (e.g., through dependency analysis and/or bottleneck detection), deadline urgency scoring (e.g., with exponential weighting for approaching deadlines), and/or shared goal contribution analysis (e.g., using weighted priority matrices). The system may implement real-time natural language processing to analyze verbal and/or text updates during meetings, extracting actionable insights such as problem-solving references between entities, generating specific recommendations like “Review EntityB's async error handling implementation from ProjectAlpha for similar timeout resolution-estimated adaptation time: 4 hours.” The AI agent instance may be trained on datasets comprising task specifications, entity performance histories, completion outcomes, and/or ground truth assignment data, implementing supervised learning techniques and/or reinforcement learning processes that dynamically adapt recommendation strategies based on assignment success rates and changing project requirements.

Examples of automatically generated task recommendations:
Skill-Based Matching Recommendations:
   For EntityBackendDeveloperA: “Recommended: Task DB-405 ‘Optimize PostgreSQL query performance for user analytics dashboard’—Match confidence: 92%. Based on your completion of 8 similar database optimization tasks with average 23% performance improvement and expertise in PostgreSQL indexing strategies demonstrated in Tasks DB-301, DB-356, DB-378.”
   For EntityFrontendDeveloperB: “Recommended: Task UI-234 ‘Implement responsive checkout flow for mobile devices’—Match confidence: 87%. Aligns with your React Native specialization (15 completed mobile tasks) and current capacity of 28 hours available within Sprint 16 timeline.”
Workload and Capacity-Based Recommendations:
   For EntityDevOpsEngineerC: “Recommended: Task INFRA-189 ‘Configure monitoring dashboards for microservices deployment’—Match confidence: 76%. Current workload: 32 hours committed, 8 hours available. Task complexity: Medium (estimated 6 hours). Deadline compatibility: 4 days remaining, fits within capacity constraints.”
   For EntityQATesterD: “Not recommended: Task TEST-567 ‘Automated testing for payment processing module’—Workload analysis shows 95% capacity utilization with 3 high-priority tasks due within 48 hours. Recommend reassignment to EntityQATesterE (current capacity: 62%).”
Dependency and Timeline-based Recommendations:
   For EntitySecurityEngineerF: “High Priority Recommendation: Task SEC-123 ‘Implement OAuth token refresh mechanism’—Critical path dependency for Tasks AUTH-401, AUTH-402 assigned to EntityBackendDeveloperA. Completion required within 24 hours to prevent 3-day delay in shared goal ‘Deploy secure authentication system by March 14th.’”
   For EntityAIAgentG: “Recommended: Task AUTO-445 ‘Generate unit tests for user registration API endpoints’—No dependencies, estimated completion time: 2.5 hours. EntityBackendDeveloperH completed registration endpoints yesterday, enabling immediate test generation without blocking conditions.”
Historical Performance-Based Recommendations:
   For EntityMobileDeveloperI: “Recommended: Task MOBILE-678 ‘Debug iOS crash on app startup’—Match confidence: 94%. Your historical bug resolution rate for iOS crashes: 87% success within 4.2 hours average completion time. Similar task MOBILE-234 completed by you 2 weeks ago with identical crash signature.”
   For EntityDataEngineerJ: “Recommended: Task ETL-356 ‘Migrate customer data from legacy CRM system’—Based on your successful completion of 12 data migration tasks with 99.2% data integrity rate and zero data loss incidents. Estimated timeline: 16 hours over 3 days, fits within current Sprint 17 capacity.”
Meeting Context-Based Recommendations:
   Generated from standup meeting input: “EntityDevOpsK mentioned: ‘We had similar deployment issues in ProjectBeta last quarter.’ Recommendation for EntityBackendDeveloperL: Review EntityDevOpsK's deployment configuration scripts from ProjectBeta (Repository: beta-deploy-configs, Branch: production-fixes) before implementing Task DEPLOY-234 ‘Configure auto-scaling for API servers.’ Estimated review time: 1 hour, implementation adaptation time: 3 hours.”
Shared Goal Optimization Recommendations:
   For EntityUXDesignerM: “High Impact Recommendation: Task UX-789 ‘Redesign user onboarding flow’—Contributes 35% toward shared goal ‘Improve user retention by 20% in Q2.’ Based on your UX optimization history showing average 18% user engagement improvements. Current shared goal progress: 47% complete, 6 weeks remaining.”
   For EntityPerformanceEngineerN: “Critical Recommendation: Task PERF-445 ‘Implement database connection pooling’—Required for shared goal ‘Achieve <500 ms API response time.’ Current system performance: 1.2 seconds average, this task projected to reduce response time by 40% based on similar optimizations you completed in Tasks PERF-201, PERF-298.”
Multi-Entity Collaboration Recommendations:
   For EntityTeamLeadP: “Collaboration Recommendation: Assign Task ARCH-567 ‘Design microservices communication protocol’ to EntitySeniorDeveloperQ (architecture expertise: 9.2/10) paired with EntityJuniorDeveloper_R (mentorship opportunity). Historical pairing success rate: 94%, estimated knowledge transfer value: High, completion timeline: 5 days.”

The analysis may include maintaining historical context across multiple historical sessions (i.e., standup meetings) presented by the interactive user interface, for example, using persistent data storage systems implementing temporal database architectures with versioned records for session data, entity performance metrics, task completion rates, and/or shared goal progression measurements across defined retention periods. The system may implements trend analysis processes (e.g., ML models, time series analysis using moving averages, linear regression models, and/or statistical process control methods) to identify recurring issues and/or progress patterns. For example, detecting that EntityDeveloperA shows consistent 15% productivity decrease during first sprint weeks across 12 historical periods, or identifying recurring “deployment pipeline failures” appearing in 8 out of 10 consecutive sessions with 4.2-hour average resolution times requiring process improvement. Progress pattern analysis utilizes velocity tracking process may compare current performance against historical baselines, generating outputs such as “shared goal ‘achieve 95% test coverage’ accelerated from 3.2% per sprint to 5.8% per sprint after sprint 6 across 16 historical sessions” and/or implementing anomaly detection (e.g., using z-score analysis and/or ML models) to identify unusual deviations from established patterns, while maintaining entity performance profiles tracking skill development progression over time with quantitative metrics showing improvement trajectories or performance degradation requiring management intervention.

In some embodiments, maintaining historical context across multiple standup sessions is implemented by generating and storing a structured “session snapshot” object for each standup meeting. A session snapshot may represent a persistent, versioned record of the state of work activity and analysis results at or near the time of a particular standup session. Each session snapshot may be stored in a session snapshot repository in association with a session identifier and a timestamp.

A not necessarily limiting example of a session snapshot data model is now described. In one implementation, each session snapshot is represented as a structured record (e.g., JSON document, relational table row set, or key-value aggregate) including:
a session_id field uniquely identifying the standup session (e.g., “STANDUP_2024-03-08_TEAM_ALPHA”);
a session_timestamp or session_datetime field indicating the date and time at which the snapshot was captured;
a timeframe_context field indicating the defined timeframe(s) in effect for the session (e.g., sprint identifier “SPRINT_15” and sprint start/end dates);
an entities_state collection containing one or more entity-level records, each entity-level record including:
   an entity_id (e.g., user identifier, AI-agent identifier);
   an entity_role (e.g., “backend_developer”, “team_lead”, “ai_agent”);
   an entity_risk_score computed at session time (e.g., numerical 0-1 or categorical);
   an entity_contribution_score indicating contribution toward the at least one shared goal during the defined timeframe up to the session time (e.g., story points completed, goal-weighted contribution, or composite metric);
   an entity_velocity_metrics structure including, for example, task completion count in the preceding interval, story points completed in the preceding interval, average completion time per task, and/or code contribution metrics;
   an entity_capacity_metrics structure including, for example, number of assigned tasks, estimated remaining hours, and capacity utilization ratio;
   an entity_feedback_summary containing aggregated customer-feedback indicators mapped to tasks owned by the entity at the time of the session (e.g., count of open feedback items, sentiment distribution);
   an entity_ai_summary_text field containing the AI-generated natural language summary that was presented (or available for presentation) in the interactive standup interface for that entity during the session; and
a tasks_state collection containing one or more task-level records, each task-level record including:
   a task_id and task_title;
   an assigned_entity_id (or indication of association with the virtual entity for unclaimed tasks);
   a task_status value (e.g., “to-do”, “in-progress”, “blocked”, “done”);
   a task_priority classification (e.g., critical/high/medium/low);
   a task_risk_score at snapshot time;
   a shared_goal_contribution_weight value indicating the relative contribution of the task to the at least one shared goal (e.g., numeric weight 0-1 or percentage contribution);
   one or more time_metrics fields such as estimated remaining time, actual elapsed time, and on-time/late flag relative to the defined timeframe; and
a team_level_metrics structure including session-wide metrics such as:
   aggregate progress toward each shared goal (e.g., percentage complete of sprint objectives);
   team velocity metrics (e.g., story points completed to date in the timeframe, tasks completed per day over the timeframe);
   aggregate risk scores for the shared goal(s);
   counts of blocked tasks, unclaimed tasks, and cross-team dependencies at session time.

The above data model is exemplary and non-limiting. In some embodiments, additional fields are included, such as: collaboration scores between pairs of entities, counts of inter-team dependencies, historical anomaly flags (e.g., identified deviations from expected performance patterns), and/or identifiers of recommendations generated and/or accepted during the session. In some embodiments, the session snapshot record is represented as a document having a hierarchical structure, such as:
session_metadata (session_id, session_timestamp, timeframe_context),
entities_state[],
tasks_state[], and
team_level_metrics.

In some embodiments, the session snapshot is automatically generated at or near the end of each standup session, or responsive to a trigger such as closing the meeting, advancing beyond a final entity in the entity navigation panel, or receiving an explicit “end meeting” input. The session snapshot may be written to a persistent storage layer (e.g., relational database, document store, or time-series database) keyed by the session identifier and/or session timestamp. Subsequent sessions may create additional snapshots, thereby forming a time-ordered series of snapshots for the same team, project, or shared goal.

In some embodiments, the one or more processors are configured to generate explicit action items and/or post-standup summaries based on the analysis performed during the standup session and the interactions with the interactive standup interface.

In one implementation, during or immediately after the time allocated to each entity in the standup session, an AI-agent instance analyzes (i) the recent work activity data for that entity, (ii) the current state of tasks assigned to that entity, (iii) risk and dependency information, and (iv) any meeting interactions associated with that entity (e.g., edits made through the interface, comments recorded during the session). Based on this analysis, the AI-agent instance generates one or more personalized next-step recommendations for the entity, each recommendation corresponding to an “action item.” An action item may include, for example: a recommended next task to start, a suggestion to unblock a particular dependency (e.g., “request review from EntityX on Task AUTH-502”), a proposed re-prioritization of assigned work, or a follow-up communication with another entity.

Each action item may be represented as a structured record including one or more of: an action item identifier; the associated entity identifier; a description field containing an AI-generated natural language description of the recommended next step; an associated task identifier or shared goal identifier; a priority level; and one or more due-date or timeframe indicators. The one or more processors may persist these action item records in a data store as part of the session snapshot for the standup session and/or in a separate action-item repository keyed by entity identifier and session identifier. In some embodiments, selected action items are also written back into the source project management system as sub-tasks, comments, or checklist items linked to existing tasks, by invoking the corresponding system's API and storing the mapping between action item identifiers and external artifact identifiers.

In addition to per-entity action items, the system may generate a post-standup summary for the meeting as a whole. After the standup concludes (e.g., after all entities in the intelligent participant ordering have been processed or upon receipt of an explicit “end meeting” input), the one or more processors may aggregate data from the current session snapshot and prior snapshots within the defined timeframe to compute updated team-level metrics. These metrics may include, without limitation: (i) velocity metrics such as story points completed since the previous standup, total story points completed in the current sprint, or tasks completed per unit time; (ii) an updated list of top risks derived from risk scores for tasks and entities, including newly elevated or mitigated risks; and (iii) communication pattern indicators, such as counts of cross-entity interactions, identification of new or persistent chase dynamics, and changes in collaboration scores between entities.

An AI-agent instance may then generate a post-standup natural language summary describing these metrics in human-readable form. For example, the summary may include statements such as “Team velocity increased from 18 to 22 story points per day since the last session,” “Two high-risk tasks were reassigned to reduce overload on EntityB,” and “Collaboration between EntityC and EntityD has improved, with average handoff delay reduced by 30%.” The post-standup summary and associated metrics may be stored in the session snapshot under a post_meeting_summary field and may also be made available through the supervisory dashboard for later review and trend analysis.

In some embodiments, the system is further configured to automatically provision the action items and post-standup summaries to external personal agents of choice associated with the entities. As used herein, a “personal agent” may include any external assistant service or agent application (e.g., a personal LLM assistant, chat bot, or productivity assistant) that is authorized to receive context about the entity's work. For each entity, the system may maintain configuration data specifying one or more personal agents to which context should be provided (e.g., a webhook endpoint, API credentials, or integration identifier) and the categories of data permitted to be shared (e.g., action items only, or action items plus post-standup summary excerpt).

After generating the per-entity action items and the post-standup summary, the one or more processors may, for each entity, construct a context payload including selected information such as: the entity's personalized action items for the session, a concise excerpt of the post-standup summary relevant to that entity (e.g., changes in team velocity or risks that directly affect the entity's tasks), and optionally compressed historical context from recent session snapshots (e.g., last N standup outcomes for that entity). The processors may then transmit this context payload to the registered personal agent for the entity using a secure communication mechanism (e.g., HTTPS API call, message bus, or standardized agent protocol).

In some implementations, the system may tag each transmitted context payload with metadata such as a session identifier, timestamp, and access-scope indicator to allow the personal agent to correlate the context with prior data and to enforce the same permissioning and redaction rules applied within the interactive standup interface. For example, for non-supervisory entities, comparative information about other entities' performance or risk scores may be omitted from the payload, whereas a team lead's personal agent may receive extended context including summarized risk rankings and collaboration metrics for the team.

By persisting action items and post-standup summaries in the session snapshot and, where applicable, writing them back into source project management systems and external personal agents, the system provides a continuous context trail that can be used both for internal trend analysis and for downstream automation, such as reminding entities of their next recommended steps or using prior standup outcomes as input to subsequent AI-based planning processes.

The analysis may include computing one or more metrics indicating a change in one or more parameters over the preceding time interval (e.g., 24 hours from the preceding standup meeting) and/or over one or more preceding time intervals, for each entity and/or each task, in view of the shared goal(s) within the defined timeframe through assessment of quantitative performance indicators, for example, using statistical methods such as percentage change calculations, rate of change derivatives, and/or trend slope analysis. The system may implement delta computation processes that calculate parameter variations using formulas such as ((CurrentValue-PreviousValue)/PreviousValue)×100 for percentage change metrics, and/or applying time-weighted moving averages to identify performance trajectory patterns across multiple measurement intervals. Technical implementations may utilize, for example, regression analysis algorithms, correlation coefficient calculations, and/or statistical significance testing to validate metric changes, ensuring computed performance variations represent genuine improvements rather than measurement noise or seasonal fluctuations, thereby providing quantitative foundation for shared goal advancement assessment within defined timeframes across diverse operational environments. Examples of metrics include:
Software Development Examples: For shared goal “deploy secure authentication system for v 2.1 release within Sprint 15 (March 1-14, 2024),” the system computes EntityBackendDeveloperA's code output metrics showing lines of code written increasing from 147 lines/day (Day 2) to 218 lines/day (Day 8), representing 48% productivity improvement, while code complexity measured by cyclomatic complexity decreased from average 4.2 to 3.1 per function indicating improved code quality. Pattern analysis across multiple 2-week intervals reveals Task “implement OAuth token validation” completion rate progressing from 2.5 validation rules implemented per day to 4.1 validation rules per day, while EntityQAEngineerB's automated test creation rate increased from 15 tests/day to 22 tests/day with code coverage for authentication modules advancing from 78% to 91%, exceeding the 85% coverage target contributing to secure system deployment shared goal.
Manufacturing Production Examples: For shared goal “increase assembly line throughput to 500 units/hour within Q2 2024,” the system computes metrics such as EntityProductionWorkerA's unit completion rate changing from 12 units/hour (Week 1) to 18 units/hour (Week 4), representing 50% productivity improvement, while tracking quality metrics showing defect rate reduction from 3.2% to 1.7% over the same period. Task-level metrics include “weld joint completion time” decreasing from 45 seconds to 32 seconds per joint across 3-week intervals, computed using temporal analysis algorithms that correlate individual entity performance with equipment utilization rates and shared production targets.
Clinical Research Examples: For shared goal “complete Phase II trial enrollment of 200 participants within 6-month recruitment period,” the system calculates EntityClinicalCoordinatorB's patient screening rate changing from 8 participants/week (Month 1) to 15 participants/week (Month 3), indicating 87.5% efficiency improvement. Pattern analysis across multiple 4-week intervals reveals cyclical enrollment variations with 23% higher recruitment during months containing medical conference periods, while Task “conduct eligibility assessments” shows average completion time decreasing from 2.3 hours to 1.8 hours per assessment through process optimization learning curves.
Construction Project Examples: For shared goal “complete 80-unit residential complex within 18-month construction timeline,” the system computes EntityElectricalContractorC's installation rate metrics showing electrical conduit installation advancing from 120 linear feet/day (Week 2) to 185 linear feet/day (Week 8), representing 54% productivity increase. Multi-interval pattern analysis identifies weather correlation factors showing 15% productivity decrease during precipitation events, while Task “install junction boxes” completion time decreased from 35 minutes to 22 minutes per unit across 6-week measurement intervals through skill development and tool optimization.
Pharmaceutical Manufacturing Examples: For shared goal “achieve 99.5% batch success rate for drug production within Q3 compliance period,” the system calculates EntityQualityControlTechnicianD's inspection throughput changing from 45 samples/day (Week 1) to 67 samples/day (Week 6), indicating 49% efficiency improvement while maintaining 99.7% accuracy rates. Pattern analysis across multiple production cycles reveals EntityProcessEngineerE's batch optimization modifications reducing manufacturing cycle time from 14.2 hours to 11.8 hours per batch, contributing 17% improvement toward production capacity shared goals.
Agricultural Operations Examples: For shared goal “harvest 2,500 acres of wheat within 21-day optimal harvest window,” the system computes EntityCombineOperatorF's harvesting rate metrics showing productivity increase from 35 acres/day (Day 3) to 52 acres/day (Day 12), representing 49% efficiency improvement correlating with equipment familiarity and field condition optimization. Multi-interval analysis tracks Task “grain moisture testing” completion frequency increasing from 12 tests/day to 19 tests/day, while average test completion time decreased from 8.5 minutes to 6.2 minutes per sample through procedural refinement.
Healthcare Operations Examples: For shared goal “reduce patient wait times to <15 minutes for 95% of appointments within quarterly improvement initiative,” the system calculates EntityNursePractitioner_G's patient consultation rate changing from 18 patients/day (Week 2) to 24 patients/day (Week 7), indicating 33% throughput improvement while maintaining patient satisfaction scores above 4.6/5.0. Pattern analysis identifies Task “patient vital sign collection” time optimization from 6.8 minutes to 4.9 minutes per patient through workflow standardization and electronic health record integration improvements.

The analysis may include detecting cross-linked tasks between entities, for example, through dependency graph processes that parse task metadata for prerequisite relationships, shared deliverables, and/or sequential workflow connections. The analysis may include detecting interaction patterns among entities, for example, using communication frequency metrics, task handoff timing measurements, and/or work synchronization patterns extracted from version control systems, project management platforms, and communication channels. The system may compute collaboration scores using weighted functions that combine multiple factors including, for example, task completion synchronization rates (e.g., measuring percentage of jointly-completed tasks delivered within agreed timeframes), communication responsiveness metrics (e.g., calculating average response times between entities on shared tasks), work distribution balance ratios (e.g., analyzing relative contribution percentages using metrics such as code commits, documentation updates, or deliverable portions), and/or dependency resolution efficiency (e.g., tracking time elapsed between task completion by Entity A and task initiation by dependent Entity B). For example, EntityFrontendDeveloperC and EntityBackendDeveloperD working on shared goal “implement user dashboard within Sprint 12” may receive collaboration score of 0.87 (scale 0-1) based on API contract agreement established within 4 hours, synchronized code integration completed with zero merge conflicts, and balanced work distribution (52% frontend, 48% backend contributions), while EntityDatabaseAdminE and EntityQATesterF receive low collaboration score of 0.34 indicating chase dynamics where database schema changes consistently delivered 18 hours after promised deadlines, causing QA testing delays averaging 2.3 days per sprint cycle. The collaboration scores and analysis outcomes are may be presented on the interactive user interaction, optionally within a private supervisory dashboards, using visual indicators, for example, such as network graphs showing entity interaction strengths, bottleneck identification alerts highlighting entities causing workflow delays, and trend analysis charts tracking collaboration effectiveness over multiple sprint periods, enabling management intervention for process optimization and resource reallocation decisions. The private supervisory dashboard may be designed to be accessible to entities having suitable access permissions, for example, based on role assignments (e.g., team lead, project manager). The private supervisory dashboard may present analytical information aggregated across multiple entities that may be selectively hidden from the main display region.

In some embodiments, the one or more processors are configured to perform collaboration and dependency analysis between pairs or groups of entities based on the work activity data, task dependency information, and/or communication events. The collaboration and dependency analysis may generate quantitative collaboration scores and detect “chase dynamics,” in which one entity repeatedly waits on another entity for prerequisite work or approvals, thereby introducing delays in achieving the at least one shared goal.

In one implementation, for each ordered pair of entities (Ei, Ej) participating in a shared goal during a defined timeframe, the system constructs a record of joint work activity derived from task assignments, dependency relationships, and historical session snapshots. For example, the one or more processors may identify: (a) tasks assigned to Ei that depend on tasks assigned to Ej (e.g., via “blocks/is blocked by” metadata in a project management system or via code ownership relationships); (b) handoff events where Ei completes a task and Ej starts a dependent task; and (c) communication events between Ei and Ej related to those tasks (e.g., comments, code review requests, or mentions in collaboration tools).

Using this data, the processors may compute a collaboration score for the ordered pair (Ei, Ej). In some embodiments, the collaboration score is a numerical value in a predefined range (e.g., 0.0 to 1.0) that reflects the effectiveness and timeliness of interactions between Ei and Ej. A non-limiting example of a collaboration score function C(Ei, Ej) is:

C(Ei, Ej)=w1×H(Ei, Ej)+w2×(1−D(Ei, Ej))+w3×R(Ei, Ej), where:
H(Ei, Ej) denotes a normalized handoff timeliness metric, for example computed as 1−(average handoff delay/maximum allowed delay) for tasks where Ei's completion enables Ej's work;
D(Ei, Ej) denotes a normalized dependency delay metric, for example computed as (average time tasks assigned to Ei are blocked waiting on Ej)/(defined timeframe or typical task duration), capped at 1; and
R(Ei, Ej) denotes a responsiveness metric, for example based on average response time to review or comment requests between Ei and Ej;

and w1, w2, and w3 denote weighting coefficients selected to emphasize desired factors (e.g., w1=0.5, w2=0.3, w3=0.2). The collaboration score thus increases when handoffs are timely and communication is responsive, and decreases when dependency delays are frequent or prolonged.

In addition to computing collaboration scores, the one or more processors may be configured to detect “chase dynamics” between entities. As used herein, “chase dynamics” refers to a pattern where an entity Ewait repeatedly experiences blocking or waiting periods due to delayed actions or responses by another entity Esource across multiple tasks or sessions. To detect chase dynamics, the system may:
identify events where tasks assigned to Ewait enter a “blocked,” “waiting for review,” or equivalent status due to a dependency on Esource (e.g., awaiting code review, approval, or upstream implementation);
for each such event, measure the blocking duration (e.g., time from entering blocked status until the dependency is resolved by Esource or the task otherwise becomes unblocked);
accumulate these blocking events over a lookback window (e.g., the last N standup sessions or the duration of the current sprint); and
compute a “chase index” CI(Ewait, Esource), such as:

CI(Ewait, Esource)=(Number_of_blocking_events×Average_block_duration)/Normalization_factor,

where the Normalization_factor may be based on the total number of tasks shared between Ewait and Esource, the length of the defined timeframe, or another scale factor. In some embodiments, the system flags a chase dynamic when CI(Ewait, Esource) exceeds a threshold and/or when the number of blocking events exceeds a count threshold over the lookback window (e.g., more than three blocks in the last five sessions with average block duration exceeding 24 hours).

The collaboration scores and chase dynamics indicators may be stored in the session snapshot described herein, for example as part of a collaboration_metrics structure including per-pair collaboration scores and chase indices for the current session. Over multiple sessions, the system may perform trend analysis on these metrics to identify improving or deteriorating collaboration patterns.

In some embodiments, the collaboration scores and chase dynamics are presented in the interactive standup interface, for example in a supervisory dashboard or team-lead risk dashboard. The team-lead view may include a “collaboration map” or “dependency map” in which entities are represented as nodes and directed edges between nodes represent collaboration or dependency relationships. The edge between Ei and Ej may be annotated with the collaboration score C(Ei, Ej), and edges associated with high chase indices CI(Ewait, Esource) may be visually distinguished (e.g., bold or red lines) to indicate problematic “chase dynamic” relationships. Selecting an edge or node in this visualization may cause the interface to display detailed metrics, such as:
the computed collaboration score and its components (e.g., average handoff delay, number of joint tasks, average response time);
the chase index and a list of representative blocking events (e.g., task identifiers, timestamps, and durations); and
historical trends across previous session snapshots (e.g., a sparkline showing increasing or decreasing collaboration score between Ei and Ej over the last 10 standups).

In some implementations, the system may generate AI-produced natural language summaries for the team-lead risk dashboard that incorporate collaboration and chase dynamics analysis. For example, the system may generate text such as: “Collaboration between EntityFrontendA and EntityBackendB is rated 0.32 (low). EntityFrontendA has been blocked waiting for EntityBackendB on 5 tasks in the current sprint, with an average block duration of 2.1 days, indicating a chase dynamic that may delay completion of the shared goal.” These summaries may be selectively presented only to entities with supervisory permissions, while redacted or omitted from the standard per-entity view as described herein in connection with access-control and redaction mechanisms.

At 206, an interactive user interface may be generated based on the analysis.

The interactive user interface may be generated by populating a template with data based on the analysis. The same template may be re-used for each daily meeting by populating the template with the recent relevant data.

The interactive user interface may be presented on a display being viewed by multiple entities. For example, the multiple entities are physically presented together in the same room viewing the same display. Alternatively, multiple instances of the daily interface are presented on multiple displays of different client terminals in network communication with one another. For example, the multiple entities are in physically different geographical areas, but are communicating via an interactive session for holding a virtual meeting.

The interactive user interface may include an entity selection mechanism for selecting a current entity whose recent work activity is being presented and discussed in the standup meeting. The entity selection mechanism includes a list of the relevant entities, optionally including absent entities. A presentation of the entities within the interactive user interface may be arranged according to a prioritization metric (e.g., condition) which may include quantitative values ranking entities based on analyzed work activity data, for example: (i) most problematic entities having highest problem severity metrics which may be computed from blocked task counts, average risk scores, and/or update staleness; (ii) entities with most assigned tasks having highest task quantity metrics which may be computed based on assigned task counts weighted by complexity and/or story points; and (iii) key task completion contributors having highest contribution significance metrics which may represent percentage of completed work advancing shared goals during defined timeframes. The prioritization metric may be computed as part of the analysis and presented simultaneously with a visual element indicating the corresponding entity (e.g., picture of the human or icon denoting an AI-agent). This enables selection of the entities with highest priority states. Exemplary entity selection mechanisms for selecting one of the entities are discussed below.

In some embodiments, the one or more processors are configured to compute an intelligent participant ordering for the plurality of entities for each standup session. The intelligent participant ordering may be applied to the entity selection mechanism, for example, by arranging the visual order of entities in the entity navigation panel and/or by determining the sequence in which entities are automatically selected during the meeting. The intelligent participant ordering may be recomputed for each new standup session, thereby producing a different speaking order for successive sessions.

In one non-limiting implementation, the intelligent participant ordering is based on a combination of randomization and prioritization logic. The system may first identify a set of entities having elevated priority for the current session, such as entities associated with tasks that are currently blocked, entities whose aggregate risk score exceeds a threshold, or entities assigned to tasks on the critical path for achieving the at least one shared goal within the defined timeframe. These elevated-priority entities may be placed at the beginning of the ordering. The system may also identify entities having lower priority for early presentation, such as a virtual entity that maintains unclaimed tasks or entities with no assigned tasks in the current sprint, and place those entities toward the end of the ordering.

Between these priority groups, the one or more processors may apply a randomized ordering process that shuffles the remaining entities subject to constraints. For example, the system may randomize the relative order of non-blocked entities while enforcing constraints such as: (i) entities with declared blockers or highest risk metrics appear first; (ii) the virtual entity appears last; and (iii) entities that spoke within the first N positions in the previous session are probabilistically demoted in the next session to prevent the same entities from always presenting first. In some embodiments, the randomized ordering may be implemented by assigning each entity a base random score for the session, then adjusting that score by adding or subtracting priority weights derived from risk, blocker, and workload metrics, and finally sorting the entities based on the adjusted scores.

The resulting session-specific participant ordering may be rendered directly in the entity navigation panel of the interactive standup interface, so that the displayed sequence of entity icons or names corresponds to the intelligent participant ordering. The same ordering may be used by the automated selection mechanism to determine the next entity when a speaking timer expires, or when a “next entity” control is activated. In some embodiments, a visual indicator (e.g., an icon or annotation) may be presented in association with entities that are prioritized due to blockers or high risk, and the virtual entity may be rendered in a visually distinct position (e.g., last in the list) to reflect its lower scheduling priority and role as a pool of unclaimed tasks.

The interactive user interface may include a main display region that presents, for the selected entity, the work activity data visualized in the context of the entity's advancement towards the at least one shared goal, which is generated based on the analysis. The main display region may present recent activity accomplishments from the preceding time interval (i.e., past time period) for the selected entity.

In the main display region, the interactive user interface may present the summary of the mapped feedback data corresponding to tasks associated with the shared goal presented for the selected entity, generated based on the analysis.

In some embodiments, the interactive standup interface displays mapped customer feedback within the main display region for tasks assigned to the selected entity. The CX feedback displayed may include one or more of the following exemplary presentations (which may be adapted accordingly):
(a) Feedback indicator icon: Displayed adjacent to task titles for tasks having associated feedback, including a comment bubble icon or numerical badge showing feedback item count.
(b) Expandable feedback panel: Activated when an entity selects a task with feedback, implemented as inline expansion below the task row, modal overlay, and/or slide-out side panel.
(c) Feedback item format: Each feedback item may display, for example: source identifier (e.g., “Support Ticket #12345”), customer comment text, metadata (timestamp, customer ID, platform), mapping confidence (e.g., “Direct match: TASK-456” or “Semantic match: 82%”), and action controls (acknowledge, remap, add note).
(d) Aggregation summary: For multiple feedback items per task, displays total count, sentiment distribution, common keywords, and time distribution above individual items.
(e) Notification badges: Displayed in the entity selection mechanism showing count of unacknowledged feedback items for each entity (e.g., red circle with “5” at top-right of entity picture).
(f) Timeline visualization: Shows feedback submission dates relative to sprint start, task start, and current date.

For example: Task “TASK-456: Implement OAuth” displays feedback indicator “[□ 3]”. When selected, expandable panel shows 3 feedback items with source, content, timestamp, mapping method, and action buttons. Aggregation summary shows “3 reports, all negative, keywords: login, timeout, iOS.”

The interactive user interface may present a graphical indicator identifying the entity that contributed most significantly toward advancement of the shared goal(s) during the defined timeframe, for example, a classification category, a color, a ranking, flashing icon, and the like. The amount of contribution provided by each entity may be computed as part of the analysis. Highest contributors may be selected first. An entity may be said to have contributed most significantly when that entity's work activity yields the highest contribution metric value among the plurality of entities during the defined timeframe. The entity with highest computed contribution score across selected metrics may be identified as contributing most significantly. Examples of contribution metrics used to identify the entity that contributed most significantly include: (a) Story point completion: sum of story points for completed tasks (e.g., EntityA: 31 points vs. EntityB: 18 points→EntityA contributed most); (b) Critical path task completion: completion of tasks blocking other work (e.g., EntityC unblocked 8 dependent tasks→higher contribution weight); (c) Goal-weighted completion: tasks weighted by percentage toward shared goal (e.g., EntityD completed tasks contributing 40% toward “deploy authentication” s. EntityE: 15%→EntityD contributed most); (d) Defect resolution impact: resolution of blockers preventing goal advancement (e.g., EntityF resolved critical bug preventing 2-day delay→high impact); and (e) Code integration volume: lines of code for goal-critical functionality (e.g., EntityG: 2,847 lines for core features vs. EntityH: 342 lines for peripheral features).

The interactive user interface may present a graphical progress indicator element depicting advancement by individual entities towards the shared goal(s) during the defined timeframe. Alternatively or additionally, the interactive user interface may present a graphical progress indicator element depicting collective advancement by a group of entities toward the shared goal during the defined timeframe. The amount of progress may be computed as part of the analysis. The graphical progress indicator element may be presented as, for example, a bar chart indicating the advancement from start to the shared goal along an axis indicating the defined timeframe. In yet another example, the graphical progress indicator is presented as a path on a graph towards the shared goal, the path indicating multiple milestones to meet or that were met during the defined timeframe. The path may be presented as a picture or an animation of a character running up a hill, the animation indicating where the character currently is along the path and the total height of the hill corresponding to the shared goal and/or defined timeframe.

In some embodiments, the interactive standup interface supports multiple view types, including a general team view and one or more supervisory views intended for entities with elevated access privileges (e.g., team leads, project managers). When switching between such views, the system may apply access-control policies and redaction rules so that certain analytical data and AI-generated summaries are only presented to entities having suitable permissions. Accordingly, the one or more processors may be are configured to determine, based on stored access-control information (e.g., role assignments, access control lists), whether a requesting entity is authorized to view supervisory data. If authorized, the processors may generate a supervisory dashboard as part of the interactive standup interface, the supervisory dashboard presenting additional contextual information (e.g., comparative risk rankings, workload balancing recommendations, cross-entity collaboration scores) that is selectively redacted from the main display region for non-privileged entities.

The interactive user interface may include an option for presenting the supervisory dashboard for access by an entity having suitable access permissions, for example, a leader of a team of the entities. The supervisory dashboard may be presented on a display of the entity with suitable access permissions. The supervisory dashboard may be omitted from displays of entities that lack the suitable access permissions. For example, when the multiple entities are in different geographical locations and communicating with each other via respective client terminals for a virtual meeting, the supervisory dashboard may be presented on the display of the supervisor and not presented on displays of the other entities. The supervisory dashboard may present additional contextual information unexposed to other entities, for example, an AI-generated natural language summary selectively redacted from the main display region for entities that do not have the suitable access permissions.

The supervisory dashboard may implement role-based redaction, for example, through:
(a) Permission verification: A permissions database may be queried to retrieve entity role assignments (e.g., “developer” vs. “team_lead”), determining which interface components are rendered.
(b) Server-side filtering: Different data payloads may be generated based on roles. Non-privileged entities may receive data excluding supervisory analytics (e.g., {own_tasks, team_progress: 71%}), while privileged entities may receive complete data including {risk_rankings, performance_comparisons, rebalancing_recommendations}.
(c) Client-side rendering control: Conditional logic may display supervisory UI components when permission flags are present in received data payloads.
(d) Dual summary generation: AI model(s) may generate standard summaries for general viewing (e.g., “EntityA completed 3 tasks”) and enhanced summaries for supervisory viewing (e.g., “EntityA completed 3 tasks, velocity −12% vs. team average, recommend workload rebalancing”), with enhanced versions presented exclusively in the supervisory dashboard.
(e) Audit logging: Supervisory data access attempts may be logged with entity identifier and timestamp; unauthorized access attempts may be blocked and logged.

For example: Developer EntityA receives interface data without supervisory analytics; the supervisory dashboard components are not rendered. Team lead EntityB receives complete data including supervisory analytics; the supervisory dashboard is accessible via navigation control.

The team lead dashboard may present the risks identified by the analysis, for example, tasks delayed for individual entities, entities with low update frequencies, task metrics for individual entity (e.g., average size task per entity), a map of task interdependencies, and other risks as described herein. The risk may be identified by another AI agent instance, which may be trained, for example, on a training dataset of sample extracted data, and a ground truth of sample risk flags.

In some embodiments, the interactive standup interface includes a team-lead risk dashboard that is a private view accessible only to entities having suitable access permissions (e.g., team leads, project managers, or other supervisory roles). The team-lead risk dashboard may be generated and rendered by the one or more processors as a specialized supervisory view that presents aggregated risk information and advanced analytics that are not exposed in the standard entity view.

The one or more processors may be configured to determine, based on stored access-control information (e.g., role assignments, access control lists, policy rules), whether a requesting entity is authorized to access the team-lead risk dashboard. For example, an access-control module may maintain mappings between entity identifiers and roles such as “developer,” “tester,” “AI agent,” “team_lead,” and “project_manager.” When an entity attempts to open the supervisory dashboard (e.g., by activating a control in the interactive standup interface), the processors may query the access-control module to verify whether the entity's role satisfies a policy indicating that the risk dashboard is restricted to supervisory roles. If the authorization check fails, the system may omit the risk dashboard view from the interface or present only a limited, redacted summary.

In some embodiments, the team-lead risk dashboard includes one or more AI-identified risk flags. The one or more processors may be configured to analyze the work activity data, task metadata, session snapshots, and interaction history using one or more AI-agent instances to identify patterns indicative of increased risk to achieving the at least one shared goal within the defined timeframe. Examples of AI-identified risk flags include, without limitation: (i) tasks whose computed risk scores exceed a threshold; (ii) entities whose aggregate risk level exceeds a threshold over multiple sessions; (iii) goals for which forecasted completion probability falls below a target value; and (iv) recurring blocker patterns associated with particular dependencies or entities. These risk flags may be presented in the team-lead risk dashboard as a prioritized list, with each flag including an indication of the associated entity or task, a risk severity level, and a short AI-generated explanation (e.g., “High risk: EntityA has three blocked critical tasks, average resolution delay 3.2 days, jeopardizing authentication deployment goal”).

The team-lead risk dashboard may further present update-frequency metrics computed per entity. For each entity, the one or more processors may compute a frequency at which the entity's tasks or work activity data are updated in the one or more databases and/or in the interactive standup interface. For example, an update-frequency metric may indicate the number of task state changes, commits, or comment events per unit time (e.g., per day) in the defined timeframe. The risk dashboard may display, for each entity, one or more of: (a) an “updates per day” value; (b) time since last update; and (c) a trend indicator derived from session snapshots (e.g., whether the entity's update frequency is increasing or decreasing across recent standup sessions). Entities whose update-frequency metrics fall below a configurable threshold may be automatically highlighted as potential risks due to inactivity or stale task states.

In addition, the team-lead risk dashboard may present an average task size metric per person. In some embodiments, each task is associated with a size indicator, such as story points, estimated hours, or another complexity measure stored in the project management system. The processors may be configured to compute, for each entity and for a given timeframe (e.g., current sprint or rolling window), an average task size based on tasks assigned to and/or completed by that entity. The dashboard may then display, for each entity, an average assigned task size and/or average completed task size, optionally side by side with team-wide averages. These averages may be used to identify imbalances in workload distribution or potential misalignment between task complexity and entity capability, and may be incorporated into AI-identified risk flags (e.g., “EntityB consistently assigned tasks above team average complexity while already at high capacity”).

In some embodiments, the team-lead risk dashboard further presents an interdependency map visualizing task and entity dependencies. The one or more processors may be configured to build a dependency graph from the tasks and entities by analyzing metadata such as explicit dependency fields in project management tools (e.g., “blocks”/“is blocked by” relationships), code ownership information, and historical task handoff patterns derived from session snapshots. The interdependency map may be rendered in the supervisory view as a graph or network diagram where nodes represent tasks and/or entities and edges represent dependency relationships. Edges or nodes associated with high-risk tasks (e.g., tasks with high task-level risk scores or repeated blocker status) may be visually emphasized (e.g., colored or highlighted), enabling a team lead to quickly identify critical bottlenecks and cascading risk paths. In some implementations, selecting a node in the interdependency map may cause the interactive standup interface to display additional details for the corresponding task or entity, such as its risk flags, update-frequency metrics, and average task size metrics.

To support permissioning and selective redaction, the system may implement server-side and client-side filtering of data presented in the team-lead risk dashboard. On the server side, when preparing data for a non-supervisory entity, the one or more processors may generate a response that excludes supervisory-only fields (e.g., cross-entity performance comparisons, detailed risk rationales, interdependency graphs with named entities). For supervisory entities, the response may include full analytics and identifiers. On the client side, the rendering logic of the interactive standup interface may be configured to instantiate the team-lead risk dashboard components only when a permission flag is present in the received data. In some embodiments, the system may generate dual versions of certain AI-generated summaries: a general version suitable for all entities, and an enhanced version containing additional supervisory context (e.g., relative risk rankings, workload rebalancing recommendations). The enhanced version may be selectively presented only in the team-lead risk dashboard and redacted from the main display region for entities lacking the corresponding permissions.

Although the team-lead risk dashboard is not shown as a separate figure, in some embodiments it may be rendered using a layout similar to interface 302 of FIG. 3, with additional panels dedicated to risk flags, update-frequency charts, average task size tables, and an interdependency map. The underlying access-control and redaction mechanisms described above ensure that sensitive comparative and supervisory analytics are visible only to authorized entities while the general standup interface remains focused on per-entity progress and task information.

Optionally, the interactive user interface is implemented as an extension for an integrated development environment (IDE). This extension may be designed for broad compatibility, aiming to facilitate real-time synchronization between a variety of project management boards, and software engineering workflows within developer tools. The IDE extension may be implemented as a plugin or software code that, upon installation, interfaces with a Model Context Protocol (MCP) coordination layer. The MCP coordination layer synchronizes metadata between active developer sessions and tasks to the entities without requiring direct, hardcoded integrations with each project management tool's specific API. Upon installation and authentication with a supported account, the IDE extension retrieves and displays tasks assigned to the entities directly within the interactive user interface inside the IDE.

The IDE extension may be designed to update task fields (e.g., status, owner, due date) from within interactive user interface. Interactions with the interactive user interface may be brokered through the MCP framework.

In implementations in which the entities include AI agent instances, the IDE Extension may interact bi-directionally with the AI Agent instances, for example, to assign unassigned tasks to the AI Agent instances, and/or to receive updates from the AI agent Instances.

Referring now back to FIG. 3, FIG. 3 illustrates an exemplary implementation of the interactive standup interface generated at 206 of the method of FIG. 2. In particular, when the one or more processors generate the interactive standup interface based on the analysis of work activity data (act 206), the user interface may be rendered in the form of interface 302, which includes an entity navigation panel, a main view region, and additional graphical indicators of progress and risk as described below. The entity selection mechanism discussed with reference to act 210 is visually implemented in FIG. 3 as entity navigation panel 304. The main display region referenced in the claims corresponds, in one embodiment, to main view 306, which is configured to present the work activity data and AI-generated summaries for the currently selected entity.

Interactive daily interactive user interface 302 may include one or more of the following windows (or regions) designed to present different data and/or for different interactions:
An entity navigation panel 304 presenting a list of entities participating in the team meeting. In some embodiments, the entities displayed in entity navigation panel 304 are arranged according to the intelligent participant ordering computed by the one or more processors for the current standup session, such that entities with blockers or elevated risk appear earlier in the list and a virtual entity representing unclaimed tasks is positioned last.
A main view 306, which may be implemented as a window.
An avatar 308 of the currently selected entity that is presenting and/or being discussed. The current entity is selected from the list of entities presented in entity navigation panel 304 using the entity selection mechanism.
A graphical progress indicator element 320 indicating progress of the selected entity with respect to work done on the tasks towards the shared goal during the predefined time interval. Graphical progress indicator may be implemented as, for example, a bar graph and/or path presenting progress of the selected entity with respect to team progress towards the shared goal. The bar graph and/or path may be visually coded (e.g., color and/or pattern) to visually indicate the progress of the selected entity with respect to team progress of the shared goal, such as by a first color denoting progress of the selected entity and a second color indicating team progress towards the shared goal.
Another region 310 presenting recent activity accomplishments (e.g., tasks) from the preceding time interval for the selected entity, for example, from the previous meeting and/or during the last 24 hours. One or more of following data may be presented for each recent activity: description of the recent activity, current status (e.g., in progress, on hold), and a proposed status change and/or a recommended future action. The recent activity may include additional data computed based on the analysis described herein.
Another region 312 presenting current tasks assigned to the selected entity, or that no tasks are currently assigned.
Yet another region 314 presenting suggestions specific for the current entity, for example, an unassigned task determined by an AI agent to be suitable for handling by the current entity. The suggestions may be automatically generated as described herein.
A count down timer 316 indicating remaining time for the current entity (e.g., to present their recent accomplishments) until another entity is selected.

Referring now back to FIG. 2, at 208, a virtual entity that maintains unclaimed tasks (i.e., not currently assigned to any other entity) associated with the shared goal(s) may be defined and/or managed. The visual entity maintains unclaimed tasks in a state that is accessible for task claiming by the other entities (e.g., each entity may manually select from these unclaimed tasks) and/or for assignment to other entities (e.g., automatically and/or by other entities such as a supervisor).

The virtual entity may be defined and presented in the interactive user interface, optionally in the entity navigation panel of the interactive user interface for selection using the entity selection mechanism.

The virtual entity is designed for automatically capturing tasks without designated owners, and in response to selection of the virtual entity, the captured tasks are presented as available work items for selection in the interactive user interface by other entities.

The virtual entity may be implemented as an AI agent instance that automatically captures tasks without designated owners and presents the captured tasks as available work items for entity selection in the interactive user interface. The AI agent instance may mine the databases to identify the unclaimed tasks, for example, by analyzing metadata tags to determine which tasks do not have owners.

The interactive user interface may present visual elements designed for individual entities to claim the captured tasks for themselves, and/or to assign the unclaimed tasks to one or more entities. Alternatively, the unclaimed tasks are automatically allocated to the entities, for example, based on availability of the entity to accept the task, semantic similarity between the unclaimed task and the current tasks assigned to the entity, the type of task and suitable experience of the entity, and the like.

While FIG. 3 illustrates the interactive standup interface when a human or AI-agent entity is selected, FIG. 4 illustrates a zoomed-in view of a similar interface when the virtual entity that maintains unclaimed tasks is selected. In particular, FIG. 4 shows how the same entity navigation panel paradigm can be extended to represent a virtual entity (406) and how main view 408 is reconfigured to display unclaimed tasks that are available for claiming or assignment.

Referring now back to FIG. 4, a zoom-in view of an interactive user interface 402 is presented. Interactive user interface 402 includes an entity navigation panel 404 presenting a list of entities, including a virtual entity 406 to which unclaimed (i.e., unassigned) tasks are assigned. Assigning the unclaimed tasks to virtual entity 406 keeps the tasks safe and/or ready for the other entities to claim (i.e., to assign). In response to selecting virtual entity 406, a main view 408 may be updated for presenting a list of the unclaimed tasks (e.g., 410) associated with virtual entity 406. Unclaimed tasks 410 may be presented with other data associated with the task, such as description of the task, task status (e.g., ready to begin), and priority (e.g., critical, high). Unclaimed tasks 410 may be sorted within main view 408, for example, according to priority, to help make sure that the most pressing unclaimed tasks are assigned first. Selection of another entity updates main view 408 for presenting the lists of tasks assigned to the newly selected entity, as described herein.

At 210, a specific entity may be selected from the list of entities presented in the interactive user interface via the entity selection mechanism. The entities for selection may be presented in an entity navigation panel within the interactive user interface.

The selection mechanism may be automatically triggered when a time counted by an individual speaking timer (i.e., timer), has elapsed. The individual speaking timer may be presented within the interactive user interface. The individual speaking timer may include a visual countdown display for each entity's speaking allocation. The timer presents an amount of time left for the currently selected entity to speak. The time limit may be configurable. For example, each entity is assigned 1 minute, 3 minutes, or other times. Each entity may be allocated the same amount of time, or different entity may be allocated different amounts of time, for example, computed based on the number of assigned tasks, priority, complexity of the tasks, and the like. For example, more junior entities with fewer tasks may be assigned less time that more senior members with more tasks. In another example, entities with more complex tasks may be assigned more time than entities with less complex tasks.

Alternatively, the selection mechanism may be triggered in response to other triggers, for example, an indication that the current entity has completed their presentation. The indication that the current entity has completed their presentation may be automatically detected, for example, by another AI-agent instance monitoring the speech of the current entity with respect to the work activity data of the entity presented within the interactive user interface. The AI-agent may be designed to determine when the entity has presented and/or covered all of the presented data, such as reading the automatically generated summarizes, and/or commenting on tasks. For example, the AI-agent analyzes speech of the current entity, such as by converting the audio to text and feeding into a large language model (LLM). The speech may be mapped to the different data presented within the interactive user interface. When a requirement indicating that the data has been covered by the speaker, the selection mechanism may be automatically triggered.

Optionally, the selection mechanism is implemented as an automated randomized selector that randomly selects each subsequent entity from the available entities presented in the entity navigation panel. The entities may be randomized for generating an unpredictable speaking order generation selected to maintain meeting engagement and/or prevent routine presentation patterns. The randomization may be based on a prioritization and/or weighing process and/or by a set of rules, for example, placing members with declared blockers first, moving unassigned members to the end of the queue, and the like. Previously selected entities are excluded from the pool of available entities for subsequent selections.

Alternatively or additionally, the selection mechanism is implemented as sequential navigation controls for manually selecting the next entity. The sequential navigation controls may include previous and next entity buttons enabling manual progression through entity presentations, for example, according to a meeting facilitator's discretion.

Alternatively or additionally, the selection mechanism may be implemented for automatically selecting the next entity using a set of rules, for example, most problematic entities (e.g., highest risk of not completing their task that jeopardizes reaching the shared goal) are selected with higher priority, entities with most assigned tasks may be prioritized for speaking first, key task completion contributors may be selected with higher priority, an entity that was in the first 3 speakers in the previous standup meeting should not be in the first 3 speakers in the next standup meeting, an entity working on a critical task should be in the first 3 speakers, entities with more seniority and/or higher standing in the hierarchy of the organization may be selected with higher priority, and the like.

Alternatively or additionally, the selection mechanism may be implemented for selecting entities according to risk scores. The risk scores are computed based on the analysis (as described herein). Entities with highest identified risk may be selected for presenting first. The computed risk scores may be hidden from the entities.

Alternatively or additionally, the selection mechanism may be implemented as an interactive element (e.g., button, arrow, link) for manually selecting the next entity. The interactive element may be automatically presented within the interactive user interface when the timer expires. The interactive element may be removed from the interactive user interface when the timer resets after selection of the next entity.

Optionally, when the selected entity is absent from the meeting, another AI agent instance may automatically present a summary of the recent work done in place of the absent entity. The AI agent may automatically present the generated natural language summary and/or may play the synthesized voice of the absent entity that is saying the generated natural language summary. The entity may be automatically identified as being absent, for example, by detecting that the entity has not logged into the meeting, performing face recognition on images of participants captured during the meeting and detecting the missing entity, accessing a log file of attendance, and the like.

At 212, one or more users (e.g., the entities and/or other users such as a technician) may interact with the interactive user interface. Examples of interactions include: touching a screen presenting the interactive user interface, typing text into designated regions of the interactive user interface, clicking on the interactive user interface with a mouse, and speaking into a microphone where the speech is analyzed to trigger the interaction with the user interface.

Interactions with the interactive user interface, such as updates and/or adaptations to the data presented by the interactive user interface, may be monitored and/or analyzed, optionally by another AI-agent instance. For example, the AI-agent instance monitors speech being recorded during the meeting for automatically updating the interactive user interface accordingly.

The interactions may be monitored and/or analyzed over one or more of: during the current time allocated for the currently selected entities, time allocated for the current entity and previously selected entities of the current standup meeting, and during one or more preceding standup meetings (e.g., current week, current month, and the like).

One or more automated processes may be triggered based on the monitoring. For example, relevant data generated by the analysis which is linked to the data being interacted with may be presented.

Optionally, one or more metrics are computed based on the monitoring of the interactions with the interactive user interface. The previously computed metrics may be dynamically updated in response to the metrics computed based on the monitoring of the interactions, and presented in the interactive user interface. Exemplary metrics include: task completion velocity, individual productivity metrics, team velocity calculations, and workload balance analysis to support management decision-making.

Alternatively or additionally, the monitored interactions are analyzed for generating, for example: predictive insights for future work capacity planning, structured meeting summaries, action item assignments, and follow-up task creation.

In some embodiments, the system records audio of at least a portion of the standup session and generates a transcript of the recorded audio using an automatic speech recognition (ASR) process. The transcript may be time-stamped and segmented into utterances and/or speaker turns, and each segment may be associated with one or more entities and a corresponding time window within the standup session.

In some embodiments, the one or more processors associate transcript segments with one or more tasks presented in the interactive standup interface. The association may be based on one or more of: (i) an identifier of a task that is spoken by a participant (e.g., a ticket number); (ii) a task selection event, deep-link open event, or editing event occurring in the interface during a time window corresponding to the transcript segment; (iii) natural language processing (NLP) of the transcript segment to extract task-related entities (e.g., component names, feature names, owners, or dependencies); and/or (iv) semantic similarity between the transcript segment and task metadata (e.g., task title, description, comments, or mapped feedback data). In some embodiments, the system maintains an association record linking a transcript segment identifier (or hash) to an internal task identifier and/or to an external task identifier of a source project management system.

In some embodiments, based on the association between transcript segments and tasks, the system automatically generates one or more task updates and/or follow-up artifacts corresponding to the discussed tasks. For example, the system may generate an update including one or more of: a status change (e.g., “in progress” to “blocked”), an assignee change, a priority change, a due date or timeframe change, an added comment, a created subtask, and/or a created follow-up task linked to the discussed task. In some embodiments, the system generates a structured representation of the update (e.g., update type, target field, proposed value, confidence score, and source transcript segment identifier) and stores the update in the session snapshot and/or an action-item repository. In some embodiments, the system applies the generated task updates to a corresponding source database by invoking an external system API (e.g., a project management platform API) using the validation and writeback workflows described herein. The system may enforce permission checks prior to writeback and may (i) automatically apply updates when a confidence threshold is satisfied, and/or (ii) present proposed updates for confirmation by an authorized user. In some embodiments, the system stores an audit record indicating the applied update, the associated task identifier, the transcript segment identifier (or hash), a timestamp, and an identifier of the user or process that approved or applied the update, thereby enabling traceability of transcript-derived modifications.

The interactions may be monitored and analyzed over multiple standup meetings for maintaining historical context across dynamic changes of the interactive user interface over the multiple standup meetings. A trend analysis may be performed for identifying recurring issues and/or team performance patterns.

The interactions may be analyzed to identify inter-team dependencies. Visibility into related team activities affecting, for example current sprint objectives, may be identified.

After the meeting another AI agent may generate summaries of insights for the team, for example, team velocity, top risks, and/or observed communication patterns. The summaries may be stored and used as a basis for comparison during future meetings, for example, whether the top risks changed, observed positive communication patterns increased, and the like.

At 214, the interactive user interface is dynamically updated in response to the interaction with the interactive user interface, for example, using an event-driven architecture that implements real-time data processing pipelines and/or automated recomputation processes. For example, the analysis described herein may be updated to incorporate new data generated by the interaction using incremental analysis processes that process delta changes without requiring full dataset recomputation, maintaining system responsiveness during active standup sessions. The recent work activity presented in the interactive user interface in response to the updated analysis may be updated accordingly through automated refresh mechanisms that trigger when underlying data changes exceed configurable threshold values, for example, metrics may be updated using real-time calculation engines that recompute collaboration scores, risk assessments, and/or progress percentages, summaries may be updated through AI agents that regenerate natural language descriptions incorporating new task status information and entity interactions, task status may be updated through bidirectional synchronization protocols that propagate changes between the standup interface and external project management systems while maintaining data consistency across multiple platforms, and/or trend analysis visualizations may be refreshed using temporal data processing processes that incorporate new historical data points for pattern recognition and forecasting calculations.

In response to selecting another entity, the interactive user interface may be dynamically updated by updating the main view for displaying the generated recent activity accomplishments for the newly selected entity, for example, through context switching processes that retrieve entity-specific data from persistent storage systems, apply goal-oriented filtering to present relevant task information associated with shared objectives, and/or render customized dashboards reflecting the selected entity's work activity patterns, risk indicators, task recommendations, and/or collaboration metrics computed in real-time based on current project status and historical performance data.

The AI-generated natural language summaries of progress towards the shared goal(s) during the defined timeframe(s), which were generated based on the analysis of the work activity data, may be dynamically presented and/or updated in response to the interactions with the interactive user interface, for example, by contextual AI processing that implements semantic analysis and/or conversational understanding capabilities. For example, in response to selection of another entity, the interactive user interface is updated to present the AI-generated natural language summary of progress for the newly selected entity by, for example, by querying the extraction engine to retrieve entity-specific progress narratives, applying persuasive relevance scoring to prioritize information most critical to shared goal advancement, and/or formatting contextual summaries that reflect the selected entity's contributions within the defined timeframe. In another example, when the AI-generated natural language summary indicates that a certain number of lines of code were written, and another entity said “Wow, that really helps me out to complete my task earlier than planned,” the system may implements real-time natural language processing to parse the verbal input, extract semantic meaning indicating task dependency relationships and/or timeline modifications, and the summary of the related task may be updated to indicate that the writing of the certain number of lines of code is helping to complete the related task earlier than planned through, for example, automated narrative adjustment processes that incorporate cross-entity feedback and/or dependency impact analysis into progress summaries, while updating timeline projections and shared goal completion estimates based on the expressed acceleration in related task completion.

The interactive user interface may provide real-time editing capabilities for each task, for example, via form-based input controls and/or inline editing functionality that implements immediate validation and persistence mechanisms, for example, for changing the status of the task using dropdown selections that trigger workflow state transitions and/or dependency cascade updates, changing the description of the task through text input fields that implement auto-save functionality and version control for audit trail maintenance, modifying task priority levels, deadline adjustments, and/or entity reassignments through interactive controls that automatically recalculate shared goal impact assessments and/or timeline feasibility analysis.

In some embodiments, the real-time editing capabilities are based on implementing a validation and writeback workflow using optimistic locking to prevent conflicting concurrent modifications. Exemplary workflow may include:
(a) Version retrieval: When an entity edits a task, the system retrieves task data with a version identifier representing the current state.
(b) Optimistic lock check: Upon submission, the system may compare the submitted version identifier to the current database version. If versions match, the modification is accepted and the version is incremented. If versions differ, a conflict is detected indicating another entity modified the task during the editing session.
(c) Conflict resolution: Upon conflict detection, the system may: (i) reject the modification, (ii) notify the entity, (iii) display current task data with updated version, and (iv) provide options to re-apply changes, discard changes, or view differences. For non-overlapping field modifications, automatic merging may be applied.
(d) Validation: Before database submission, client-side validation may verify: field format compliance, required field population, dependency relationship integrity, entity permissions, and business rule compliance. Validation failures prevent submission and display error messages.
(e) Atomic writeback: Successful modifications may execute atomic database transactions that, for example: update task data, increment version identifier, record audit trail, trigger cascade updates, and broadcast change notifications to other active interface instances.
(f) Real-time synchronization: Change notifications may be propagated via WebSocket connections, polling mechanisms, or server-sent events, triggering automatic interface updates to display current database state.

The classified currently active tasks may include real-time task status analysis with editable task assignments may enable real-time task modification during standup meetings through AI-powered classification processes that continuously evaluate task states, for example, based on completion percentage, blocker conditions, dependency relationships, and/or entity capacity utilization, while providing drag-and-drop reassignment capabilities and/or instant impact analysis showing how modifications affect shared goal achievement probabilities and/or timeline projections. The interactive user interface may be adapted according to the real-time edits by, for example, event-driven update mechanisms that implement cascading change propagation, for example, updating status of related tasks through dependency graph processes that identify downstream impacts and/or automatically adjust dependent task timelines, priority levels, and/or resource allocation requirements, updating automatically generated summaries through AI narrative regeneration that incorporates modified task information into entity progress reports and shared goal advancement calculations, recalculating collaboration scores when task reassignments occur between entities, and/or refreshing risk analysis indicators when task status changes affect shared goal completion probability assessments.

In response to an interaction with an indication of a certain task presented within the interactive user interface, the task in the source database may be opened, for example, through API integration protocols that establish secure connections with external project management systems, retrieve comprehensive task metadata including comments, attachments, historical changes, and/or related documentation, and the interactive user interface may be updated for presenting the opened task through, for example, modal dialogs, embedded frames, and/or new interface panels that display full task details while maintaining context within the standup session. The updating of the interactive user interface enables accessing detailed task information, modify task parameters directly in source systems, and/or return to the standup interface with synchronized data reflecting any changes made during the detailed task review process.

At 216, real-time task status synchronization may be performed in response to the real time editing of one or more tasks presented by the interactive user interface.

The real-time task status synchronization may be performed by communicating with connected external systems and/or platforms hosting the database(s) for updating the task status according to changes made to currently active tasks via the interactive user interface.

The real-time synchronization may be performed by sending bi-directional updates between the interactive user interface and the external project management system for consistent task state visibility. For example, the task status presented by the interactive user interface may be dynamically updated in real time in response to an update made to the project management system by another external process (i.e., excluding the interactive user interface).

The bi-directional synchronization may be managed by the MCP layer. The communication between the MCP and the project management platforms may occur via their respective APIs, such as GraphQL APIs, enabling the synchronization of data from the interactions with the interactive user interface. The MCP may manage the abstraction and necessary transformations for these diverse platforms.

At 218, one or more features described with reference to 202-216 may be iterated, for example, in response to selection of another entity, prior to the next standup meeting, in response to new data entered into the database, and the like.

In some embodiments, the system and interactive standup interface operate in end-to-end workflows that span multiple upstream and downstream systems. Several non-limiting example scenarios are now described to illustrate such flows.

In a first exemplary scenario, the system is deployed in a software development environment in which the one or more databases include a project management platform (e.g., Jira™) and a code repository (e.g., Git-based source control), and further include a repository of customer experience (CX) feedback data (e.g., support tickets, product reviews, or NPS survey responses). During a preceding time interval (e.g., the 24 hours since the last daily standup), an ingestion engine accesses the Jira issues and Git commit metadata via respective APIs, and also ingests CX feedback items from a CRM or support system. The processing and normalization pipeline generates knowledge objects capturing, for example, each updated Jira task, each relevant Git commit, and each CX feedback item, with temporal stamps and vector embeddings.

The one or more processors then analyze the work activity data and the feedback data for each of entities (e.g., developers, QA engineers, AI agents) in view of a defined sprint timeframe and at least one shared goal (e.g., “deploy secure authentication system by March 14, 2024”). The analysis includes: (i) mapping CX feedback to specific tasks in Jira using a combination of explicit identifiers and semantic similarity between feedback text and task descriptions; (ii) computing contribution and risk metrics per entity and per task, such as story points completed, number of high-priority bugs resolved, code review throughput, and risk scores indicating likelihood of not achieving the sprint objective; and (iii) determining an ordering of entities for the standup based on a prioritization condition, such as “most problematic entities” (highest risk scores), “entities with most assigned tasks,” or “key task completion contributors” as described herein.

Prior to the daily standup, the system generates the interactive standup interface for the current session. The entity navigation panel lists the entities in the computed prioritized order, optionally with visual badges indicating risk level and/or presence of new CX feedback. When the standup begins and a particular entity is selected, the main display region is populated with: (a) a graphical progress indicator element showing that entity's advancement toward the shared goal relative to the sprint timeline; (b) a list of recent activity accomplishments derived from Jira and Git events during the preceding interval; (c) a summary of mapped CX feedback items for tasks currently assigned to that entity; and (d) an AI-generated natural language summary that concisely describes what the entity achieved, what is in progress, and any blockers or risks.

During the standup, a user may interact with a specific task displayed in the main display region. For example, selecting a Jira issue in the interface may trigger a deep link and/or embedded view of the corresponding task in the source project management system. From within this view, and still inside the interactive standup interface, the user may edit task fields such as status (e.g., moving from “in progress” to “blocked”), priority, or assignee. The system applies validation and writeback workflows as described herein and sends updates back to Jira via its API. These edits cause the risk analysis and per-entity metrics to be recomputed in real time, and the interface dynamically updates the displayed risk indicators and AI-generated summaries accordingly.

As each entity completes their portion of the standup, the system may generate per-person action items and recommendations based on the updated analysis. For example, after reviewing the entity's current workload, risk score, and mapped feedback, the system may recommend specific next tasks to pull from the backlog, or suggest cross-team collaboration actions (e.g., “coordinate with EntityBackendB on Task AUTH-402 to resolve shared dependency”). These action items may be stored, for example, as structured records in the session snapshot for that standup and optionally written back as sub-tasks or comments in the underlying project management tool.

In some embodiments, the system concurrently transcribes the standup conversation and, when participants discuss a particular Jira issue, automatically proposes and/or applies transcript-derived updates to that issue (e.g., adding a comment, creating a follow-up subtask, or updating a status field) subject to authorization and validation controls

At or near the conclusion of the standup session, the system may generate a post-standup summary capturing updated team velocity, top risks, and notable changes in progress toward the shared goal. For instance, the system may compute the change in total completed story points since the last standup, update a sprint burn-down or burn-up trajectory, and recompute a forecasted probability of meeting the sprint deadline. It may then persist this information in a session snapshot as described herein and present a concise natural language summary to the team or to a supervisory dashboard (e.g., “Team velocity increased from 18 to 23 story points/day; risk of missing authentication deployment deadline decreased from high to medium after reassignment of Task AUTH-401”). This post-standup summary provides a concrete tracking artifact that can be compared across multiple sessions for trend analysis.

In a second exemplary scenario, the system operates as a stand-in for an absent teammate. Prior to the standup, the system determines that a particular entity has not joined the session (e.g., based on meeting attendance logs, calendar integration, or lack of a client terminal connection). The system then verifies authorization for generating and presenting an automatic update for that entity. For example, a permission database may specify that the entity has opted in to auto-generated standup summaries, and that the requesting team or team lead has sufficient access rights to view the entity's work activity. If authorization is confirmed, the system analyzes the recent work activity data of the absent entity (e.g., Jira tasks updated, Git commits made, code reviews completed) during the preceding time interval, and generates an AI-produced natural language summary that follows the team's expected standup pattern (e.g., “Yesterday I finished implementing Task AUTH-410, today I plan to start Task AUTH-415, I am blocked on database credentials from DevOps”). The system may mark this summary internally as “auto-generated” and associate it with a suitable flag in the session snapshot. When the entity's turn arrives in the entity navigation panel, the interactive standup interface can surface this auto-generated summary in the main display region and optionally have it read aloud via text-to-speech. The interface may also visually indicate that the update is an automatic stand-in (e.g., with a label such as “AI-generated on behalf of EntityX”). If access permissions are insufficient, the system may instead display a limited placeholder (e.g., “No authorized data available for absent entity”) or a restricted, redacted summary derived only from public or team-wide visible data.

In a third exemplary scenario, the virtual entity is used to manage ownerless tasks. During ingestion and analysis, the system identifies tasks in the project management database that do not have a valid assigned owner (e.g., newly created items in the backlog, tasks whose assignee field is empty or set to a placeholder, or tasks whose previous owner has left the team). The one or more processors assign these unclaimed tasks to a designated virtual entity, which appears in the entity navigation panel alongside human entities and AI-agent instances. When a participant selects the virtual entity during the standup, the main display region displays a prioritized list of unclaimed tasks associated with the at least one shared goal, sorted for example by urgency, risk impact, or dependency criticality. For each unclaimed task, the interface may show a brief description, current status (e.g., “ready to begin”), priority classification (e.g., critical, high, medium, low), and any mapped CX feedback indicating customer demand or severity.

Meeting participants may interact with this list to claim or assign tasks in real time. For example, a developer may select an unclaimed task and activate a “claim” control in the interactive standup interface, causing the system to update the task assignment from the virtual entity to that developer. Alternatively, a team lead may use a reassignment control to allocate the task to another entity determined by the system to be a good fit (e.g., based on capability and capacity analysis). In either case, the system writes back the owner change to the underlying project management system via its API, updates internal metrics (e.g., reducing the count of unclaimed tasks, adjusting entity workloads), and dynamically refreshes both the virtual entity view and the assigned entity's view. Accordingly, the virtual entity serves as a live “pool” of ownerless tasks that can be resolved during the standup with immediate, synchronized updates to the source databases.

In a fourth exemplary scenario, the system summarizes work performed by multiple AI agents overnight for consumption by a manager or team lead. In some embodiments, one or more of the entities include AI-agent instances configured to automatically perform work activity on allocated tasks toward the shared goal (e.g., code generation, automated test creation, data transformation jobs). During non-meeting hours, these AI agents may execute numerous operations, creating substantial changes in work activity data between standup sessions. Prior to the morning standup, the ingestion engine collects logs, outputs, and metadata for each AI-agent instance from relevant databases and services (e.g., CI/CD pipelines, test runners, code repositories). The analysis module aggregates this work activity per AI-agent instance, computing metrics such as number of tasks advanced or completed, lines of code or test cases generated, failure/success rates, and impact on shared goal progress (e.g., test coverage increase, defect risk reduction).

The interactive standup interface may present each AI agent as a selectable entity in the entity navigation panel, enabling the team to view a concise AI-generated summary in the main display region similar to a human participant. Additionally or alternatively, the supervisory dashboard for a manager or team lead may include a dedicated “multi-agent rollup” view that aggregates all AI-agent activity for the preceding time interval. In this view, the system may display per-agent summaries (e.g., “AIAgent-Tests generated 42 new unit tests for the payment module, raising coverage from 81% to 89%; AIAgent-Docs produced updated API documentation for three new endpoints”), along with combined impact metrics, such as net lines of code accepted into the main branch, aggregate test coverage improvements, and any new risks detected (e.g., flaky tests, build failures). The manager can drill down into individual AI-agent updates, open specific tasks or code changes via deep links, and, where appropriate, reassign follow-up human review tasks in real time. The system may store these AI-agent rollups in the session snapshot as part of team-level and entity-level metrics, enabling subsequent trend analysis of how AI-generated work contributes to shared goal progress across multiple standup sessions.

These scenarios are exemplary and not limiting. They demonstrate how the disclosed system and interactive standup interface can integrate heterogeneous data sources (e.g., project management tools, code repositories, feedback systems), apply AI-based analysis and summarization, support real-time interaction and writeback during the standup meeting, and maintain historical session-level context for subsequent trend tracking and risk assessment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant interactive user interfaces will be developed and the scope of the term interactive user interface is intended to include all such new technologies a priori.

As used herein the term “about” refers to ±10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for generating an interactive standup interface, comprising:
one or more processors configured to:
analyze work activity data of each of a plurality of entities from one or more databases hosting tasks associated with at least one shared goal, wherein the work activity data corresponds to at least one defined timeframe for assessing progress towards the at least one shared goal;
generate an interactive standup interface based on the analysis, the interactive standup interface comprising an entity selection mechanism and a main display region that presents, for a selected entity, work activity data visualized in a context of the entity's advancement towards the at least one shared goal; and
dynamically update the interactive standup interface in response to a user interaction with the interactive standup interface, by presenting AI-generated natural language summaries of progress towards the at least one shared goal during the at least one defined timeframe based on the analysis of the work activity data, and/or opening the task in the source database according to the user interaction.

2. The system of claim 1, wherein the one or more databases comprise at least one of: software development repositories, project management systems, and work management platforms.

3. The system of claim 1, wherein the one or more processors are configured to access a repository of feedback data associated with the at least one shared goal, and map the feedback data to tasks associated with the at least one shared goal, and the interactive standup interface presents a summary of the mapped feedback data corresponding to tasks associated with the at least one shared goal presented for the selected entity.

4. The system of claim 1, wherein the entity selection mechanism comprises an entity navigation panel presenting a list of the plurality of entities for selection.

5. The system of claim 1, wherein the one or more processors are configured to manage a virtual entity that maintains unclaimed tasks associated with the at least one shared goal, the unclaimed tasks being accessible for assignment to available entities.

6. The system of claim 5, wherein the virtual entity is configured for automatically capturing tasks without designated owners, and in response to selection of the virtual entity, the captured tasks are presented as available work items for selection in the interactive standup interface by other entities.

7. The system of claim 1, wherein the one or more processors are configured to generate AI-powered risk analysis for each task indicating likelihood of not achieving the at least one shared goal during the at least one defined timeframe, and/or compute a general risk level for each entity indicating likelihood of not achieving the at least one shared goal during the at least one defined timeframe based on task completion patterns and timeline adherence.

8. The system of claim 1, wherein the one or more processors are configured to arrange a presentation of the plurality of entities within the interactive standup interface according to a prioritization condition selected from: most problematic entities, entities with most assigned tasks, and key task completion contributors.

9. The system of claim 1, wherein the one or more processors are configured to generate the AI-generated natural language summaries of progress for entities that are absent, based on analysis of the work activity data of the absent entities.

10. The system of claim 1, wherein the interactive standup interface further comprises a supervisory dashboard for access by an entity having suitable access permissions, the supervisory dashboard presenting additional contextual information unexposed to other entities, the additional contextual information including an AI-generated natural language summary selectively redacted from the main display region for entities that do not have the suitable access permissions.

11. The system of claim 1, wherein the interactive standup interface presents a graphical indicator identifying the entity of the plurality of entities that contributed most significantly toward advancement of the at least one shared goal during the at least one defined timeframe.

12. The system of claim 1, wherein the interactive standup interface presents a graphical progress indicator element depicting advancement by individual entities towards the at least one shared goal during the at least one defined timeframe, and presenting collective advancement by a group of entities toward the at least one shared goal during the at least one defined timeframe.

13. The system of claim 12, wherein the graphical progress indicator is presented as a path on a graph towards the at least one shared goal, the path indicating a plurality of milestones to meet or that were met during the at least one defined timeframe.

14. The system of claim 1, wherein at least one of the plurality of entities is an AI-agent instance designed to automatically perform work activity on allocated tasks towards the at least one shared goal, wherein the one or more processors analyze work activity data of the AI-agent instance, wherein the work activity data is associated with the at least one shared goal and corresponds to the at least one defined timeframe.

15. The system of claim 1, wherein the one or more processors are configured to: generate classification labels for currently active tasks assigned to entities and presented within the interactive standup interface, and provide real-time editing capabilities via the interactive standup interface for enabling immediate task modification.

16. The system of claim 1, wherein the one or more processors are configured to generate task recommendations for future work assignments for each entity, based on at least one of: capability of the entity, capacity of the entity, and the at least one shared goal.

17. The system of claim 1, wherein the one or more processors are configured to maintain historical context across a plurality of historical sessions presented by the interactive standup interface and provide trend analysis for recurring issues and/or progress patterns toward the at least one shared goal.

18. The system of claim 1, wherein the at least one defined timeframe corresponds to an Agile development sprint period, and the at least one shared goal includes sprint objectives for software development project completion.

19. A computer-implemented method for generating an interactive standup interface, comprising:
analyzing work activity data of each of a plurality of entities from one or more databases hosting tasks associated with at least one shared goal, wherein the work activity data corresponds to at least one defined timeframe for assessing progress towards the at least one shared goal;
generating an interactive standup interface based on the analysis, the interactive standup interface comprising an entity selection mechanism and a main display region that presents, for a selected entity, work activity data visualized in a context of the entity's advancement towards the at least one shared goal; and
dynamically updating the interactive standup interface in response to a user interaction with the interactive standup interface, by presenting AI-generated natural language summaries of progress towards the at least one shared goal during the at least one defined timeframe based on the analysis of the work activity data, and/or opening the task in the source database according to the user interaction.
